(19) United States
(12) Patent Application Publication
(10) Pub. No.: US 2026/0104546 A1
(43) Pub. Date: Apr. 16, 2026

(54) SEMICONDUCTOR PHOTONICS DEVICES AND METHODS OF FORMATION

(71) Applicant: Taiwan Semiconductor Manufacturing Company, Ltd., Hsinchu (TW)

(72) Inventors: Wen-Shun LO, Zhudong Township (TW); Chun-Heng CHEN, Hsinchu City (TW); YingKit Felix TSUI, Cupertino, CA (US)

(21) Appl. No.: 18/916,862

(22) Filed: Oct. 16, 2024

(51) Int. Cl. G02B 6/13; G02B 6/12

(52) U.S. Cl. CPC G02B 6/13; G02B 2006/12142; G02B 2006/12169

(57) ABSTRACT

A waveguide structure (e.g., a dielectric edge coupler waveguide, a metal edge coupler waveguide) of a semiconductor photonics device is formed and processed using high-temperature processing techniques to achieve a low hydrogen concentration for the waveguide structure prior to formation of semiconductor photonics components of the semiconductor photonics device that are susceptible to damage from high-temperature processing such as metal silicide layers and/or semiconductor-based photodetector absorption regions. The high-temperature processing of the waveguide structure may be performed as part of a high-temperature processing operation for other structures of the semiconductor photonics device, such as an annealing operation for source/drain regions of transistor structures of the semiconductor photonics device.

### BACKGROUND

Photonics integrated circuits (PICs) can include multiple types of waveguides that are configured to perform different functions. Semiconductor waveguides (e.g., silicon (Si) waveguides) are often used in optical modulators because of the capability of modulating refractive indices in semiconductor waveguides by applying electric fields to the semiconductor materials of the semiconductor waveguides. Dielectric waveguides are often used for signal propagation and/or edge coupling because of the lower optical loss and higher thermal stability compared to the semiconductor materials of semiconductor waveguides.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A and 1B are diagrams of an example of a semiconductor photonics device described herein.

FIG. 2 is a diagram of an example of different device regions of a semiconductor photonics device described herein.

FIGS. 3A-3H are diagrams of an example implementation of forming a semiconductor photonics device described herein.

FIG. 4 is a diagram of an example of a semiconductor photonics device described herein.

FIGS. 5A-5M are diagrams of an example implementation of forming a semiconductor photonics device described herein.

FIG. 6 is a diagram of an example of a semiconductor photonics device described herein.

FIGS. 7A-7O are diagrams of an example implementation of forming a semiconductor photonics device described herein.

FIG. 8 is a flowchart of an example process associated with forming a semiconductor photonics device described herein.

FIG. 9 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Semiconductor waveguides and other semiconductor photonics components of a semiconductor photonics device may be formed in a top silicon layer of a silicon on insulator (SOI) substrate of the semiconductor photonics device. Layers and structures that are formed after formation of the semiconductor photonics components may be limited in the types of processing techniques and/or processing parameters that may be used to form the layers and structures. For example, the semiconductor photonics components formed in the top silicon layer may have limits for the temperatures to which the semiconductor photonics components may be exposed, which limits the types of semiconductor processing techniques and/or processing parameters that may be used to form a dielectric edge coupler waveguide above the top silicon layer. Exposing the semiconductor photonics components formed in the top silicon layer to temperatures that are too high may damage and/or degrade the performance of these semiconductor photonics components. For example, active components such as optical modulator structures and/or photodetectors may be formed in the top silicon layer, and silicide layers for the contacts of the active components may be susceptible to material migration and/or increased contact resistance due to high-temperature processing. As another example, active components such as photodetectors may have epitaxially grown regions of semiconductor material such as germanium (Ge), and these epitaxially grown regions may be susceptible to increased dark current (which may cause decreased sensitivity and/or decreased low-light performance) due to high-temperature processing. Thus, the formation of the dielectric edge coupler waveguide may be limited to low-temperature processing techniques so that damage to the active components can be avoided.

The dielectric material of the dielectric edge coupler waveguide may have increased susceptibility to hydrogen (H) absorption and retention at lower processing temperatures, resulting in increased hydrogen concentration in the dielectric edge coupler waveguide. For example, the dielectric etch coupler waveguide may be formed of a silicon nitride (SiₓN_{y}), which may have a high concentration of silicon (Si) and nitrogen (N) dangling bonds that are prone to absorbing hydrogen through the formation of silicon-hydrogen (Si—H) bonds and nitrogen-hydrogen (N—H) bonds. The hydrogen absorbed in the dielectric edge coupler waveguide may cause optical absorption in the dielectric edge coupler waveguide, and therefore the increased hydrogen concentration in the dielectric edge coupler waveguide may result in increased optical loss in the dielectric edge coupler waveguide. Thus, the low-temperature processing techniques may result in lower performance (e.g., lower efficiency and reduced optical communication bandwidth) for the dielectric edge coupler waveguide than if high-temperature processing techniques where used.

In some implementations described herein, a waveguide structure (e.g., a dielectric edge coupler waveguide, a metal edge coupler waveguide) of a semiconductor photonics device is formed and processed using high-temperature processing techniques to achieve a low hydrogen concentration for the waveguide structure prior to formation of semiconductor photonics components of the semiconductor photonics device that are susceptible to damage from high-temperature processing such as metal silicide layers and/or semiconductor-based photodetector absorption regions. The high-temperature processing of the waveguide structure may be performed as part of a high-temperature processing operation for other structures of the semiconductor photonics device, such as an annealing operation for source/drain regions of transistor structures of the semiconductor photonics device.

In this way, the waveguide structure may be formed and treated with high-temperature processing techniques without concern for potential damage and/or degraded performance that might otherwise be caused to the semiconductor photonics components if the waveguide were formed and treated with high-temperature processing after the semiconductor photonics components are formed. The use of the high-temperature processing techniques may enable low optical loss to be achieved for the waveguide structure in that the high-temperature processing techniques may be used to achieve a low hydrogen concentration (e.g., low concentrations of silicon-hydrogen bonds and nitrogen-hydrogen bonds) in the waveguide structure, with minimal to no impact on the optical coupling performance between the waveguide structure and the semiconductor photonics components. The low hydrogen concentration in the waveguide structure enables higher performance to be achieved for the waveguide structure, including greater operating efficiency and increased communication bandwidth. Moreover, the high-temperature processing techniques may enable the waveguide structure to be formed to have greater surface uniformity and smoothness than if low-temperature processing techniques were used, resulting in higher quality interfaces between the waveguide structure and the surrounding dielectric layers, thereby enabling increased optical confinement (and reduced optical loss) to be achieved in the waveguide structure.

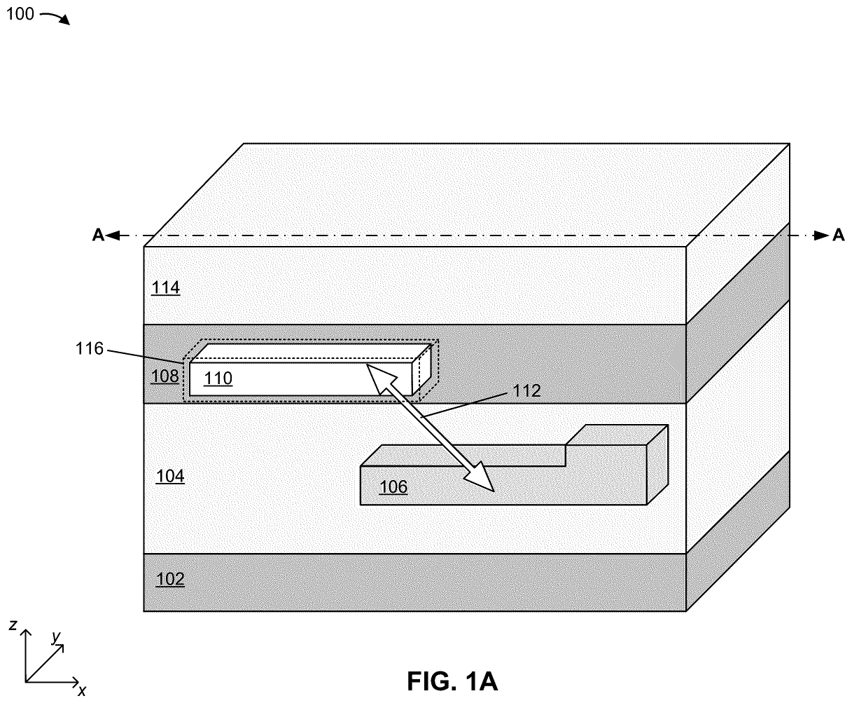

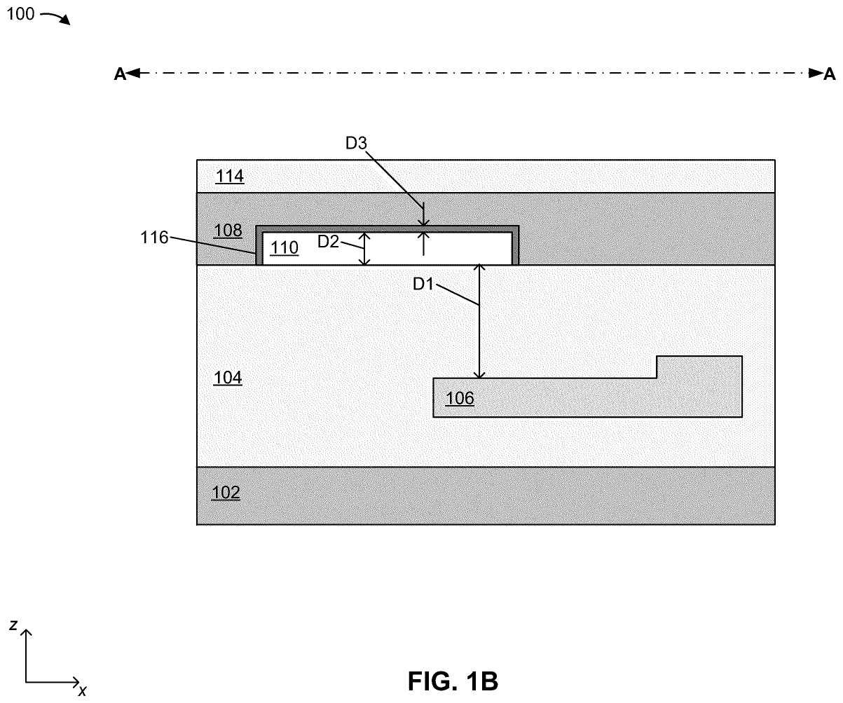

FIGS. 1A and 1B are diagrams of an example of a semiconductor photonics device 100 described herein. The semiconductor photonics device 100 may include a photonic integrated circuit that includes a plurality of optical components, such as a dielectric waveguide structure and a semiconductor waveguide structure. The dielectric waveguide structure and the semiconductor waveguide structure are optically coupled to facilitate the transfer of optical signals between the dielectric waveguide structure and the semiconductor waveguide structure. Moreover, the dielectric waveguide structure and the semiconductor waveguide structure are formed using processing techniques described herein such that the dielectric waveguide structure is below the semiconductor waveguide structure. This enables the dielectric waveguide structure to be formed prior to the semiconductor waveguide structure and other semiconductor photonics components of the photonic integrated circuit, which provides greater processing flexibility when forming the dielectric waveguide structure and enables high-temperature processing techniques to be used to form the dielectric waveguide structure.

FIG. 1A illustrates a perspective view of the semiconductor photonics device 100. As shown in FIG. 1A, the semiconductor photonics device 100 may include a substrate layer 102 (e.g., a silicon (Si) substrate and/or another type of semiconductor substrate) and a dielectric layer 104 over and/or on the substrate layer 102. The dielectric layer 104 may include a buried oxide or bottom oxide (BOX) layer, a silicon oxide layer (SiOₓ such as SiO₂), an undoped silicate glass (USG) layer, and/or another type of oxide dielectric layer.

A semiconductor waveguide structure 106 may be included in the dielectric layer 104. The semiconductor waveguide structure 106 may include one or more semiconductor materials, such as silicon (Si), silicon doped with one or more types of dopants (e.g., p-type dopants, n-type dopants), germanium (Ge), silicon germanium (SiGe), a III-V semiconductor material (e.g., a semiconductor material that includes one or more group III elements of the periodic table and one or more group V elements of the periodic table), and/or another suitable semiconductor material. The semiconductor waveguide structure 106 may include an elongated structure that extends in the x-direction in the semiconductor photonics device 100. Optical signals may propagate through the semiconductor waveguide structure 106 primarily in the x-direction. The semiconductor waveguide structure 106 may be formed from a semiconductor layer that is etched to define the semiconductor waveguide structure 106. In the example illustrated in FIG. 1A, the semiconductor waveguide structure 106 has a strip waveguide structural shape.

However, the semiconductor waveguide structure 106 may conform to other structural shapes, such as a rib waveguide structural shape and/or a tapered waveguide structural shape, among other examples.

Another dielectric layer 108 is included above the dielectric layer 104, and a waveguide structure 110 is included in the dielectric layer 108. The dielectric layer 108 may include a silicon oxide layer (SiOₓ such as SiO₂), a USG layer, and/or another type of oxide dielectric layer. In some implementations, the waveguide structure 110 is an edge coupler waveguide that is configured to receive optical signals from and/or provide optical signals to an optical fiber, a fiber optic cable, and/or another type of external optical connection. Additionally and/or alternatively, the waveguide structure 110 may be configured as another type of waveguide structure. The waveguide structure 110 may be located above the semiconductor waveguide structure 106 (e.g., at a higher z-direction position in the semiconductor photonics device 100 than the semiconductor waveguide structure 106) and may be at least partially laterally offset from the semiconductor waveguide structure 106 in the x-direction. The waveguide structure 110 may be physically separated from the semiconductor waveguide structure 106 by the dielectric layers 104 and 108, which provides optical isolation while still permitting coupling of optical signals 112 between the semiconductor waveguide structure 106 and the waveguide structure 110 at the end of the semiconductor waveguide structure 106 facing the end of the waveguide structure 110.

In some implementations, the waveguide structure 110 is a dielectric waveguide structure. In these implementations, the waveguide structure 110 may include a nitride dielectric layer that includes a nitride dielectric material having a refractive index greater than the refractive index of silicon dioxide, such as silicon nitride (SiₓN_{y} such as Si₃N₄). Additionally and/or alternatively, the waveguide structure 110 may include another type of dielectric material, such as an aluminum oxide material (AlₓO_{y} such as Al₂O₃), an aluminum nitride material (AIN), a hafnium oxide material (HfOₓ such as HfO₂), a titanium oxide material (TiOₓ such as TiO₂), a zinc oxide material (ZnO), and/or a germanium oxide material (GeOₓ such as GeO₂), lithium niobate (LiNbO3), and/or other examples.

In some implementations, the waveguide structure 110 is a metal waveguide structure. In these implementations, the waveguide structure 110 may include a metal material such as copper (Cu), tungsten (W), titanium (Ti), and/or ruthenium (Ru), among other examples.

The waveguide structure 110 may include an elongated structure that extends in an x-direction in the semiconductor photonics device 100. Optical signals may propagate through the waveguide structure 110 primarily in the x-direction. The shape of the waveguide structure 110 may include a strip waveguide structure, a rib waveguide structure, a deep rib waveguide structure, and/or another type of waveguide structure.

As further shown in FIG. 1A, another dielectric layer 114 (e.g., a third dielectric region) may be located above the dielectric layer 108. The dielectric layer 114 may be referred to as a backend dielectric layer (or a back end of line (BEOL) dielectric layer) in that backend metallization layers of the semiconductor photonics device 100 may be formed in the dielectric layer 114. The dielectric layer 114 may include a silicon oxide layer (SiOₓ such as SiO₂), a USG layer, a silicon oxynitride (SiON) layer, and/or another type of dielectric layer.

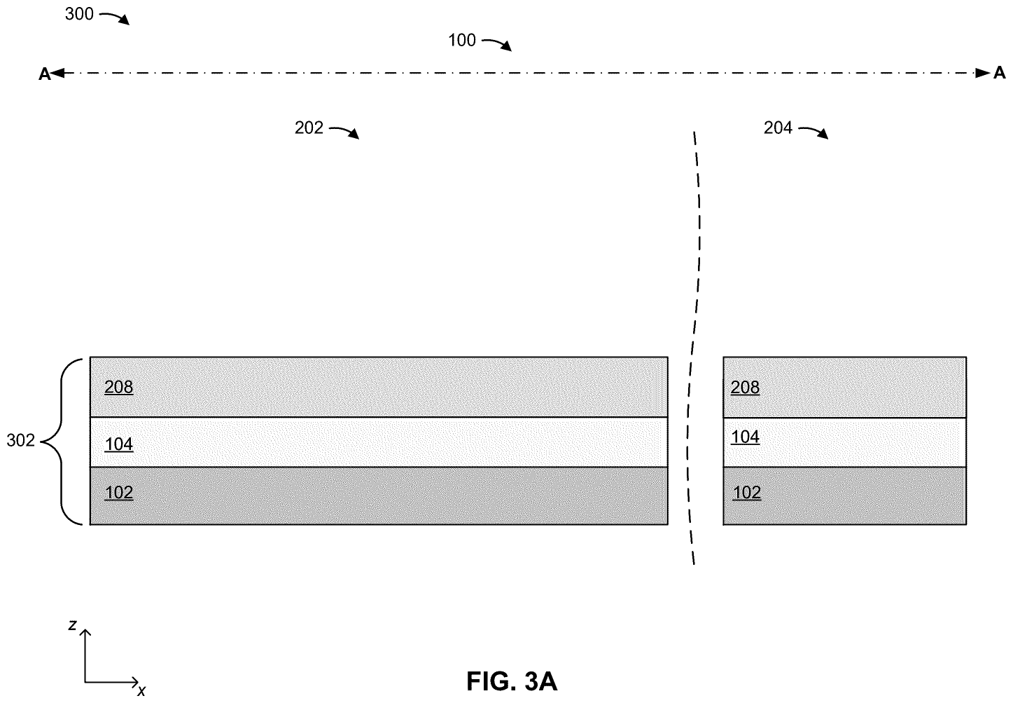

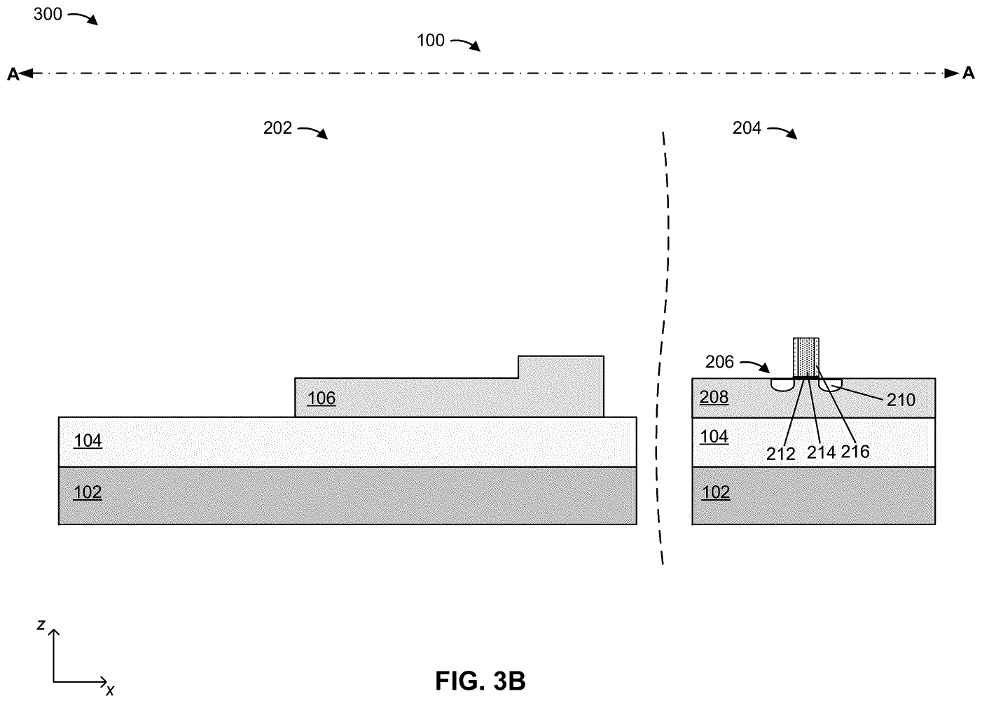

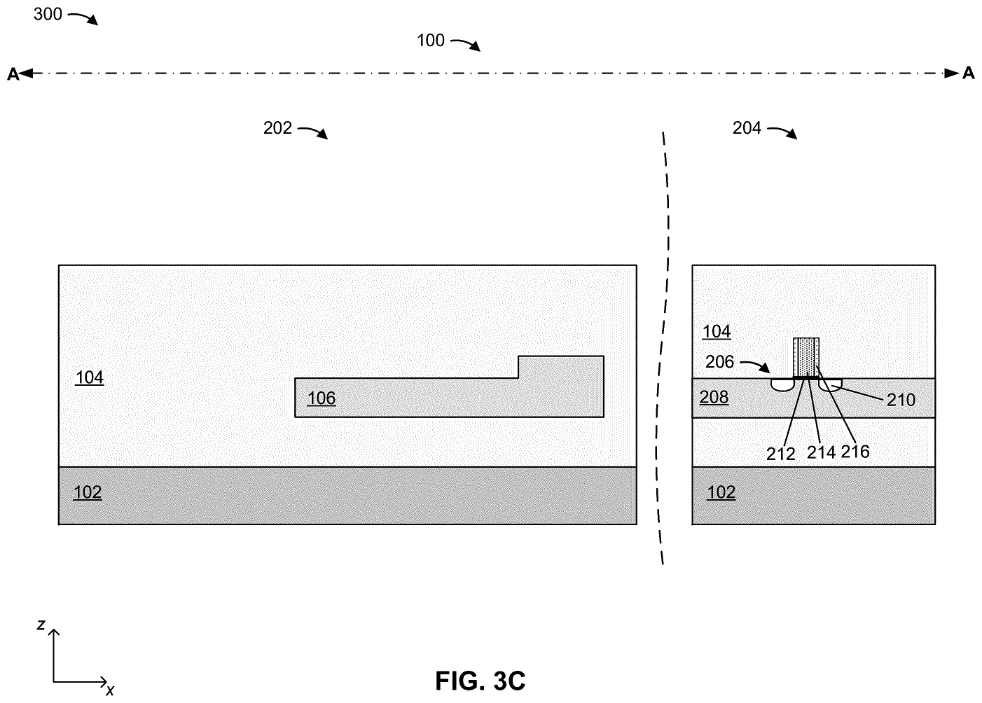

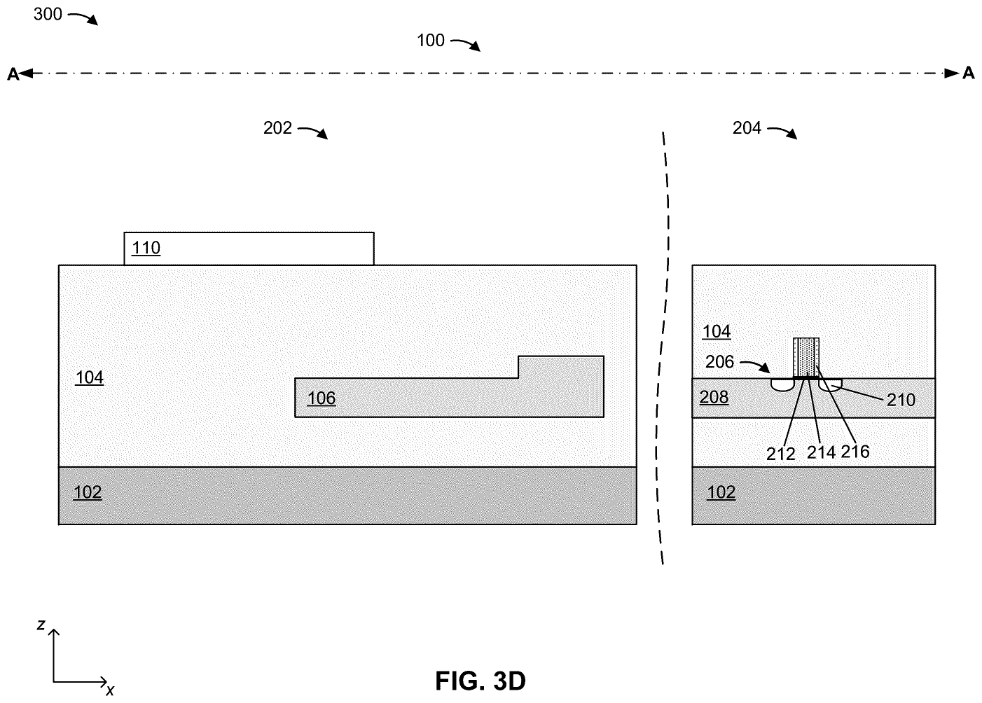

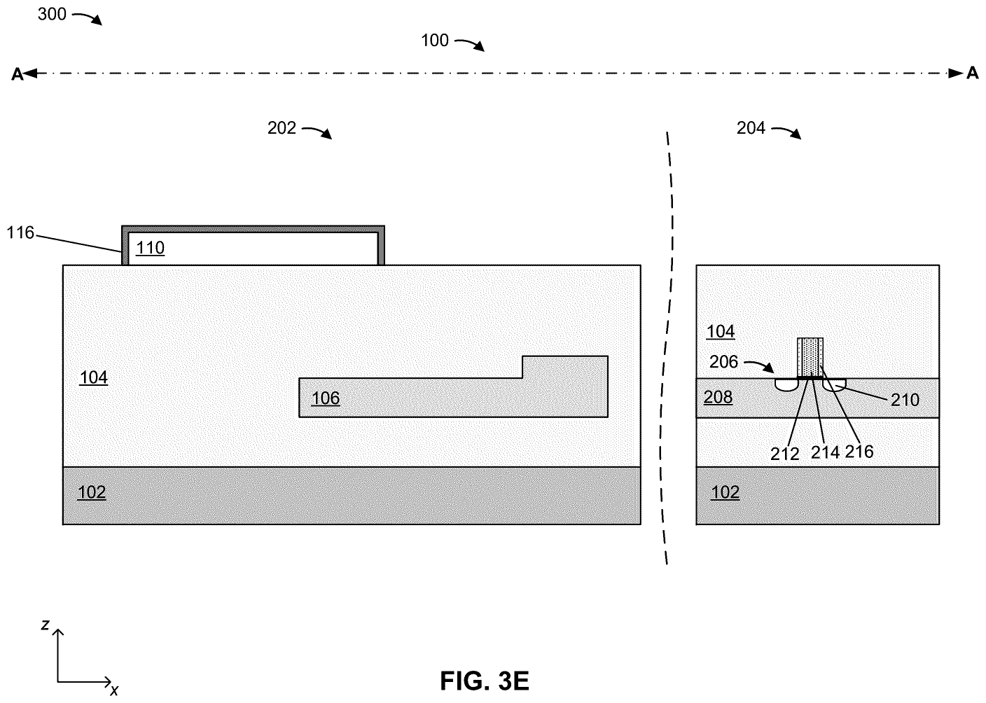

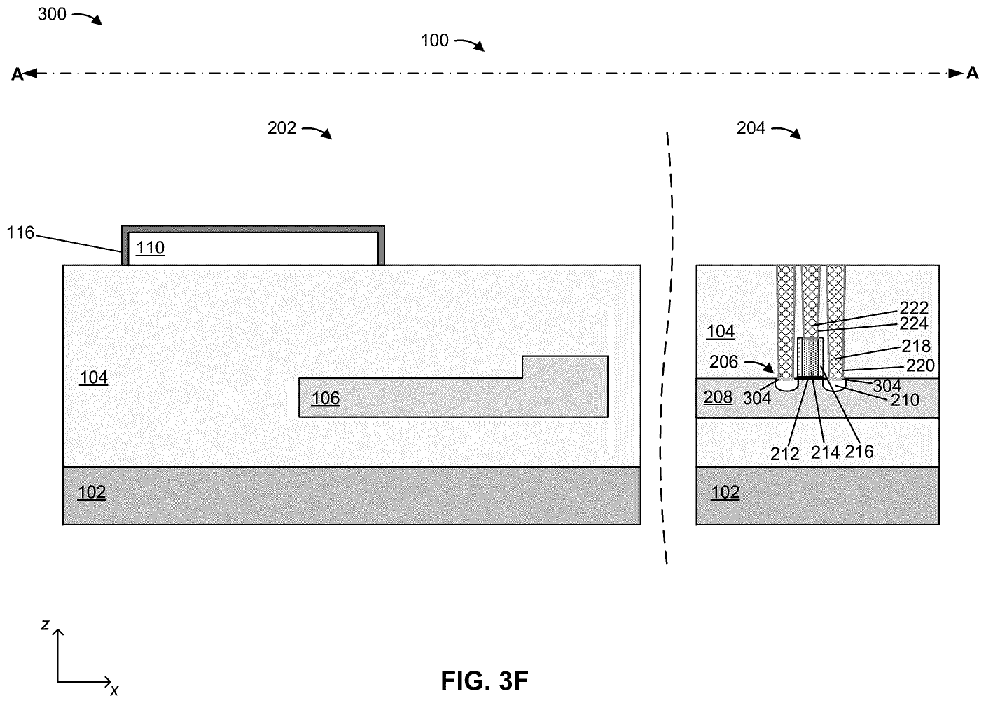

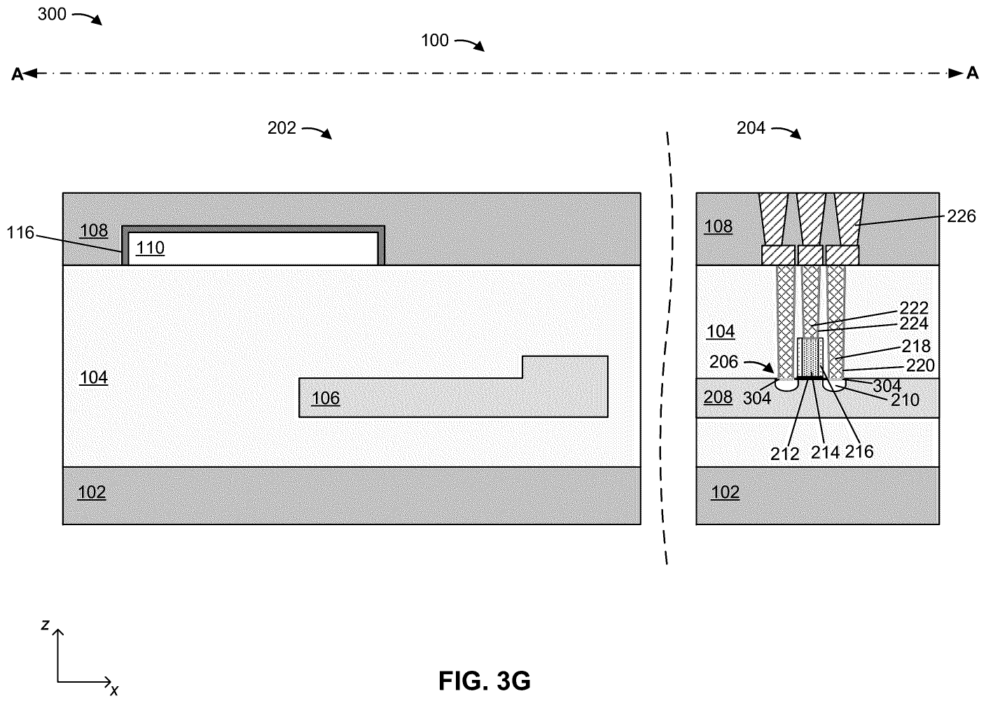

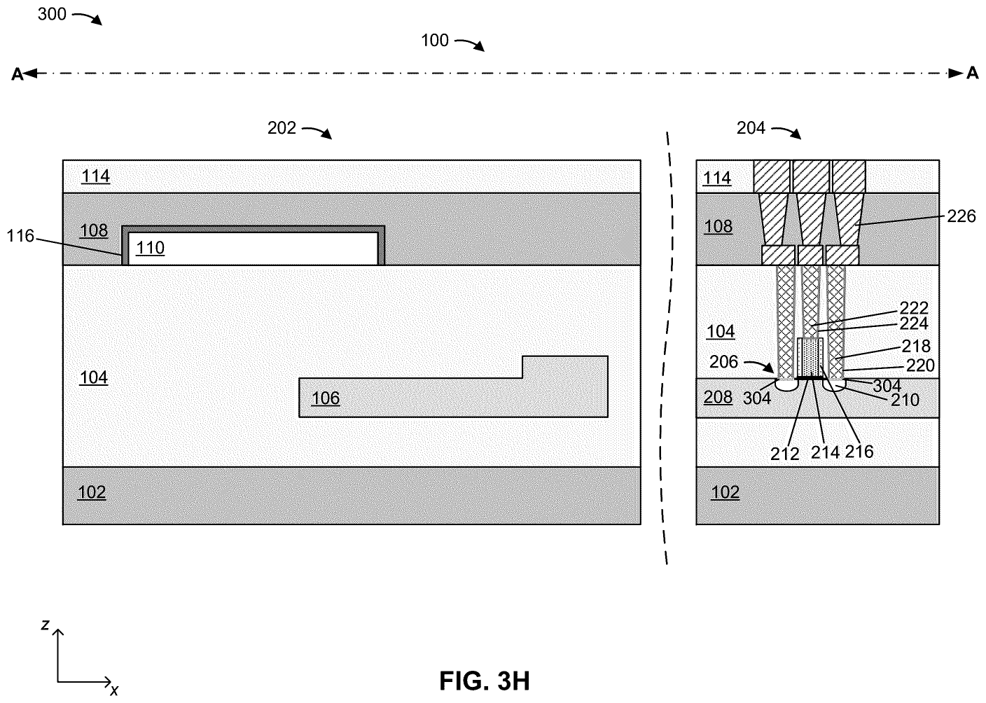

As described herein, such as in connection FIGS. 3A-3H, waveguide structure 110 may be formed using high-temperature process techniques such as annealing to achieve a low hydrogen concentration in the waveguide structure 110. High-temperature processes for forming the waveguide structure 110 may be performed prior to formation of temperature-sensitivity layers and/or components formed in and/or from the semiconductor layer in which the semiconductor waveguide structure 106 was formed, such as metal silicide layers for transistor structures formed in and/or on the semiconductor layer. For example, a high-temperature annealing operation for driving out hydrogen from the waveguide structure 110 may be performed as part of a source/drain anneal for annealing the source/drain regions of the transistor structures (which is performed prior to formation of the metal silicide layers on the source/drain regions). This enables a low hydrogen concentration (e.g., a low concentration of silicon-hydrogen bonds, a low concentration of nitrogen-hydrogen bonds) to be achieved in the dielectric material (e.g., silicon nitride (SiₓN_{y} such as Si₃N₄)) of the waveguide structure 110. For example, the hydrogen concentration in the waveguide structure 110 may be less than approximately 10% by weight of the material of the waveguide structure 110 after the source/drain annealing operation, may be less than approximately 10% by volume of the material of the waveguide structure 110 after the source/drain annealing operation, may be less than approximately 10% of the atomic composition of the material of the waveguide structure 110 after the source/drain annealing operation, and/or may be another hydrogen concentration after the source/drain annealing operation. The hydrogen concentration in the waveguide structure 110 after the source/drain annealing operation may be detected by Fourier transform infrared spectroscopy (FTIR) and/or by another type of spectroscopy.

A cladding layer 116 may be included over the waveguide structure 110. For example, the cladding layer 116 may be included on the sidewalls of the waveguide structure 110 that extend in the x-direction, may be included on ends of the waveguide structure 110 that extend in the y-direction, and may be included on the top surface of the waveguide structure 110. The cladding layer 116 may be formed as a result of the high-temperature processing that is performed on the waveguide structure 110 to achieve the low hydrogen concentration in the waveguide structure 110. The cladding layer 116 may be omitted from the bottom surface of the waveguide structure 110 in that the waveguide structure 110 may be formed on the dielectric layer 104 (or may be formed on another dielectric layer), and the high-temperature processing may be formed on the waveguide structure 110 after the waveguide structure 110 is formed on the dielectric layer 104.

The cladding layer 116 may include a dielectric cladding layer, and may include one or more dielectric materials such as silicon dioxide (SiO₂), among other examples. The silicon dioxide material of the cladding layer 116 may have one or more properties that are different from the properties of the silicon dioxide material of the dielectric layer 108 because of the high-temperature processing that results in the formation of the cladding layer 116. For example, the cladding layer 116 may have a higher density than the density of the dielectric layer 108.

As another example, the dielectric layer 108 has a first etch rate for an etchant (e.g., for a silicon dioxide etchant such as hydrofluoric acid (HF) or diluted hydrofluoric acid (DHF)), and the cladding layer 116 has a second etch rate for the etchant that is different than the first etch rate. The first etch rate of the dielectric layer 108 may be greater than the second etch rate of the cladding layer 116 because the cladding layer 116 was formed due to high-temperature processing operations performed for the waveguide structure 110. In some implementations, the difference between the first etch rate of the dielectric layer 108 and the second etch rate of the cladding layer 116 can be used to detect the use of high-temperature processing for the waveguide structure 110. For example, etchant staining (e.g., HF staining or DHF staining) can be detected in a scanning electron microscope (SEM) image of a cross-section of the semiconductor photonics device 100, and the etchant staining (e.g., the size, the color) may be different for the dielectric layer 108 and for the cladding layer 116, thereby indicating the interface between the dielectric layer 108 and the cladding layer 116.

FIG. 1B illustrates a cross-sectional view of the semiconductor photonics device 100 along the line A-A in the x-direction in FIG. 1A. Thus, the location of the cross-section view of the semiconductor photonics device 100 in FIG. 1B is along the waveguide structure 110 and along the semiconductor waveguide structure 106. As shown in FIG. 1B, an end of the semiconductor waveguide structure 106 may be facing an end of the waveguide structure 110. The end of the waveguide structure 110 that is facing the semiconductor waveguide structure 106 may be located above, and may overlap with, a portion of the semiconductor waveguide structure 106. The region of overlap between the waveguide structure 110 and the semiconductor waveguide structure 106 may be a transition region between the waveguide structure 110 and the semiconductor waveguide structure 106.

As further shown in FIG. 1B, the semiconductor waveguide structure 106 and the waveguide structure 110 may be vertically spaced apart in the z-direction by a distance (indicated in FIG. 1B as a dimension D1). In some implementations, the vertical (z-direction) distance between the semiconductor waveguide structure 106 and the waveguide structure 110 is included in a range of approximately 50 nanometers to approximately 400 nanometers. However, other values and other ranges for the vertical (z-direction) distance between the semiconductor waveguide structure 106 and the waveguide structure 110 are within the scope of the present disclosure.

As further shown in FIG. 1B, the waveguide structure 110 may have a dimension D2 corresponding to a z-direction thickness of the waveguide structure 110. In some implementations, the z-direction thickness of the waveguide structure 110 is included in a range of approximately 10 nanometers to approximately 50 nanometers to achieve sufficient confinement and low loss for optical signals in the waveguide structure 110, depending on the wavelengths of the optical signals and/or other parameters of the waveguide structure 110 such as material and refractive index. However, other values and ranges for the z-direction thickness of the waveguide structure 110 are within the scope of the present disclosure.

As further shown in FIG. 1B, the cladding layer 116 on the waveguide structure 110 may have a dimension D3 corresponding to a thickness of the cladding layer 116. The dimension D3 may refer to the vertical thickness of the cladding layer 116 on the top surface of the waveguide structure 110 and/or may refer to the lateral thickness of the cladding layer 116 on the sidewalls and ends of the waveguide structure 110. In some implementations, the thickness of the cladding layer 116 is included in a range of approximately 2 nanometers to approximately 10 nanometers, depending on the duration of the high-temperature processing performed for the waveguide structure 110 and/or oxidation rate of the material of the waveguide structure 110. However, other values and ranges for the thickness of the cladding layer 116 are within the scope of the present disclosure.

As indicated above, FIGS. 1A and 1B are provided as an example. Other examples may differ from what is described with regard to FIGS. 1A and 1B.

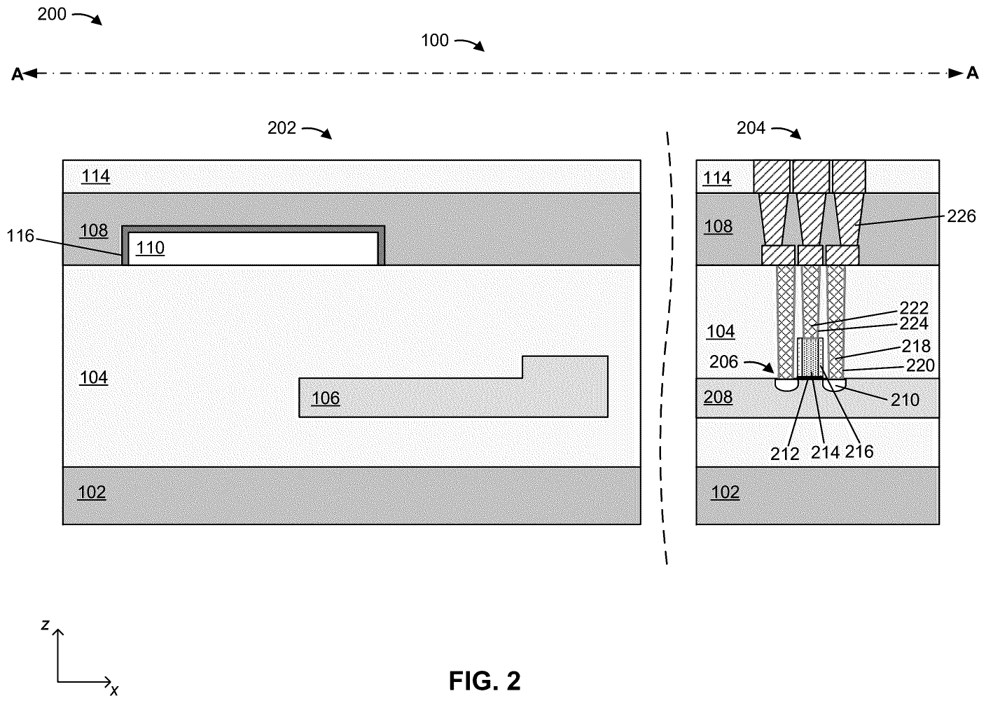

FIG. 2 is a diagram of an example 200 of different device regions of the semiconductor photonics device 100 described herein. The device regions may include a photonics region 202 and a logic region 204, among other examples. The photonics components of the semiconductor photonics device 100, such as the semiconductor waveguide structure 106 and the waveguide structure 110, may be included in the photonics region 202. Various logic components of the semiconductor photonics device 100, such as transistor structures 206, may be included in the logic region 204.

As shown in FIG. 2, the transistor structures 206 may be formed in a semiconductor layer 208 of the semiconductor photonics device 100. The semiconductor waveguide structure 106 and/or other semiconductor photonics components in the photonics region 202 may also be formed from the semiconductor layer 208. A transistor structure 206 may include a planar transistor, a fin field effect transistor (finFET), a nanostructure transistor (e.g., a nanowire transistor, a nanosheet transistor, a gate-all-around (GAA) transistor, a multi-bridge channel transistor, a nanoribbon transistor, a complementary field effect transistor (CFET)), and/or other another type of transistor structure.

As shown in FIG. 2, a transistor structure 206 may include a plurality of source/drain regions 210 that are grown and/or otherwise formed in the semiconductor layer 208. “Source/drain region(s)” may refer to a source or a drain, individually or collectively, dependent upon the context. The source/drain regions 210 may be formed by epitaxially growing doped semiconductor regions and/or by another semiconductor process. In some implementations, the source/drain regions 210 are formed in recessed portions in the semiconductor layer 208. The recessed portions may be formed by strained source/drain (SSD) etching of the semiconductor layer 208 and/or another type etching operation.

Moreover, the source/drain regions 210 may be subjected to a source/drain annealing operation in which high-temperature processing is used for various purposes such as dopant activation in the source/drain regions 210. As described in connection with FIGS. 3A-3H, the waveguide structure 110 is formed prior to the source/drain annealing operation being performed, and the source/drain annealing operation is used to perform high-temperature processing for the waveguide structure 110 to achieve a low hydrogen concentration in the waveguide structure 110. The source/drain annealing operation results in formation of the cladding layer 116 on the waveguide structure 110.

The transistor structure 206 may further include a gate dielectric layer 212 between a gate structure 214 and the semiconductor layer 208. In some implementations, the gate dielectric layer 212 includes a low dielectric constant (low-k) dielectric material such as silicon oxide (SiOₓ). In some implementations, the gate dielectric layer 212 includes a high dielectric constant (high-k) dielectric material such as hafnium oxide (HfOₓ). The gate structure 214 may be located laterally between the source/drain regions 210. In some implementations, the gate structure 214 is formed of a polysilicon material. In these implementations, the polysilicon material may be doped with one or more types of dopants (e.g., p-type dopants, n-type dopants) to tune a work function of the gate structure 214. In some implementations, the gate structure 214 is formed of one or more metal materials (e.g., tungsten (W), titanium (Ti), cobalt (Co), and/or another metal). In these implementations, the gate structure 214 may include one or more types of metals (e.g., p-type metals, n-type metals) for tuning the work function of the gate structure 214.

Sidewall spacers 216 may be included on the sidewalls of the gate structure 214 to provide electrical isolation for the gate structure 214, among other examples. The sidewall spacers 216 may include a silicon oxide (SiOₓ), a silicon nitride (SiₓN_{y}), a silicon oxycarbide (SiOC), a silicon oxycarbonitride (SiOCN), and/or another suitable material.

The source/drain regions 210 are electrically coupled and/or physically coupled with source/drain contacts 218. The source/drain contacts 218 may include contact vias, contact plugs, and/or another type of contact structures. The source/drain contacts 218 include cobalt (Co), ruthenium (Ru), and/or another electrically conductive material or metal material. One or more liner layers 220 may be included on sidewalls of the source/drain contacts 218. The liner layer(s) 220 may include a barrier layer that is included to prevent or minimize diffusion of materials from the source/drain contacts 218 to the surrounding dielectric layers, an adhesion layer or glue layer that is included to promote adhesion between the source/drain contacts 218 and the surrounding dielectric layers, and/or another type of liner. Examples of materials for the liner layer(s) 220 include titanium nitride (TiN), tantalum nitride (TaN), and/or another suitable liner material.

The gate structure 214 maybe electrically coupled and/or physically coupled with a gate contact 222. The gate contact 222 may include a contact via, a contact plug, and/or another type of contact structure. The gate contact 222 may include cobalt (Co), ruthenium (Ru), and/or another electrically conductive material or metal material. One or more liner layers 224 may be included on sidewalls of the gate contact 222. The liner layer(s) 224 may include a barrier layer that is included to prevent or minimize diffusion of materials from the gate contact 222 to the surrounding dielectric layers, an adhesion layer or glue layer that is included to promote adhesion between the gate contact 222 and the surrounding dielectric layers, and/or another type of liner. Examples of materials for the liner layer(s) 224 include titanium nitride (TiN), tantalum nitride (TaN), and/or another suitable liner material.

As further shown in FIG. 2, interconnect structures 226 may be included in one or more dielectric layers above the transistor structure 206, such as in the dielectric layer 108 and/or in the dielectric layer 114, among other examples. The interconnect structures 226 may include metallization layers, interconnect layers, and/or other types of conductive structures that electrically interconnect the transistor structures 206 in the logic region 204 and/or that electrically connect the transistor structures 206 in the logic region 204 to other regions of the semiconductor photonics device 100. The interconnect structures 226 may each include one or more electrically conductive materials such as tungsten (W), cobalt (Co), ruthenium (Ru), titanium (Ti), aluminum (Al), copper (Cu), gold (Au), and/or a combination thereof, among other examples of electrically conductive materials.

The source/drain contacts 218 may electrically connect the source/drain regions 210 of the transistor structure 206 with the interconnect structures 226 of the semiconductor photonics device 100. The gate contact 222 may electrically connect the gate structure 214 of the transistor structure 206 with the interconnect structures 226 of the semiconductor photonics device 100. Alternatively, the gate structure 214 may be electrically coupled and/or physically coupled directly with the interconnect structures 226.

As indicated above, FIG. 2 is provided as an example. Other examples may differ from what is described with regard to FIG. 2.

FIGS. 3A-3H are diagrams of an example implementation 300 of forming the semiconductor photonics device 100 described herein. In particular, the example implementation 300 includes an example of forming photonic structures in the photonics region 202 of the semiconductor photonics device 100, and forming logic structures in the logic region 204 of the semiconductor photonics device 100. In some implementations, one or more of the operations described in connection with FIGS. 3A-3H may be performed using one or more semiconductor processing tools, such as a deposition tool, an exposure tool (e.g., a lithography tool), a developer tool, an etch tool, a planarization tool (e.g., a chemical-mechanical planarization (CMP) tool, a wafer grinding tool), an ion implantation tool, an annealing tool, and/or a wafer/die transport tool, among other examples.

As shown in FIG. 3A, a substrate 302 of the semiconductor photonics device 100 may be provided. The substrate 302 may include an SOI substrate that includes the substrate layer 102 (e.g., a silicon (Si) substrate and/or another type of semiconductor substrate), a portion of the dielectric layer 104 (e.g., a BOX layer and/or another type of insulator layer) over and/or on the substrate layer 102, and the semiconductor layer 208 (e.g., a silicon (Si) layer and/or another type of semiconductor layer) over and/or on the portion of the dielectric layer 104. Alternatively, the substrate layer 102 may be provided as a semiconductor wafer, and a deposition tool may be used to form the portion of the dielectric layer 104 over and/or on the substrate layer 102, and may be used to form the semiconductor layer 208 over and/or on the portion of the dielectric layer 104. A deposition tool may be used to deposit the portion of the dielectric layer 104 using a chemical vapor deposition (CVD) technique, a physical vapor deposition (PVD) technique, an atomic layer deposition (ALD) technique, an oxidation technique (e.g., a thermal oxidation technique), and/or another type of deposition technique. A deposition tool may be used to form the semiconductor layer 208 using an epitaxy technique and/or another type of deposition technique.

As shown in FIG. 3B, the semiconductor waveguide structure 106 may be formed from the semiconductor layer 208 above the dielectric layer 104 in the photonics region 202. In some implementations, other semiconductor photonics components are formed from the semiconductor layer 208, in addition to the semiconductor waveguide structure 106. In some implementations, a hard mask layer may be formed over and/or on the semiconductor layer 208, and a pattern in the hard mask layer may be used to etch the semiconductor layer 208 to form the semiconductor waveguide structure 106. Deposition tools may be used to deposit the hard mask layer on the semiconductor layer 208 (e.g., using a CVD technique, a PVD technique, and/or another type of deposition technique) and a photoresist layer on the hard mask layer (e.g., using a spin-coating technique and/or another type of deposition technique). The hard mask layer may include a silicon nitride (SiₓN_{y} such as Si₃N₄) material or another hard mask material. The photoresist layer may include a light-sensitive material that can be patterned using an exposure tool such as a deep ultraviolet (DUV) lithography tool and/or an extreme ultraviolet (EUV) lithography tool, among other examples.

An exposure tool may be used to expose the photoresist layer to a radiation source to form a pattern in the photoresist layer. A developer tool may be used to develop and remove portions of the photoresist layer to expose the pattern. An etch tool may be used to etch the hard mask layer to transfer the pattern from the photoresist layer to the hard mask layer. An etch tool may then be used to etch the semiconductor layer 208 based on the pattern in the hard mask layer to remove material from the semiconductor layer 208 to form the semiconductor waveguide structure 106. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique).

As further shown in FIG. 3B, the gate dielectric layer 212 of the transistor structure 206 may be formed on the semiconductor layer 208 in the logic region 204. The gate structure 214 of the transistor structure 206 may be formed on the gate dielectric layer 212. The sidewall spacers 216 may be formed on the sidewalls of the gate structure 214. The source/drain regions 210 of the transistor structure 206 may be formed in the semiconductor layer 208.

In some implementations, a dummy gate structure (e.g., a temporary gate structure) is formed in place of the gate structure 214, and the dummy gate structure is used as a self-aligned pattern for forming the source/drain regions 210. For example, the dummy gate structure may be used to etch the semiconductor layer 208 (e.g., using an etch tool) to form source/drain recesses in the semiconductor layer 208, and may be used to epitaxially grow (e.g., using a depositing tool) the source/drain regions 210 in the source/drain recesses. The dummy gate structure may be subsequently removed and replaced with the gate structure 214. In this way, the gate structure 214 is not damaged by the processes used to form the source/drain regions 210.

As shown in FIG. 3C, additional material of the dielectric layer 104 may be deposited around and/or on the semiconductor waveguide structure 106 in the photonics region 202 such that the semiconductor waveguide structure 106 is encapsulated in the dielectric layer 104. Moreover, the additional material of the dielectric layer 104 may be deposited around and/or on the transistor structure 206 in the logic region 204 such that the transistor structure 206 is encapsulated in the dielectric layer 104. A deposition tool may be used to deposit the additional material of the dielectric layer 104 using a CVD technique, a PVD technique, an oxidation technique, and/or another type of deposition technique. In some implementations, a planarization tool is used to perform a planarization operation (e.g., a CMP operation) to planarize the dielectric layer 104 after the additional material of the dielectric layer 104 is deposited.

As shown in FIG. 3D, the waveguide structure 110 may be formed on the dielectric layer 104 in the photonics region 202. In some implementations, a layer of dielectric material is deposited on the dielectric layer 104, and the layer of dielectric is patterned and etched to define the waveguide structure 110. The layer of dielectric material may be deposited to a thickness of approximately 200 nanometers to approximately 700 nanometers, and a planarization tool may be used to perform a planarization operation (e.g., a CMP operation) to remove material from the layer of dielectric material such that the z-direction thickness of the waveguide structure 110 is included in a range of approximately 10 nanometers to approximately 50 nanometers. However, other values and ranges for the thickness of the layer of dielectric material and the thickness of the waveguide structure 110 are within the scope of the present disclosure.

A deposition tool may be used to deposit the layer of dielectric material from which the waveguide structure 110 is formed. A CVD technique, a PVD technique, an oxidation technique, and/or another type of deposition technique may be used to deposit the layer of dielectric material. In some implementations, a relatively low-temperature deposition process such as plasma-enhanced CVD (PECVD) may be used to deposit the layer of dielectric material at a temperature of approximately 450 degrees Celsius or less. In some implementations, a high-temperature deposition technique, such as low-pressure CVD (LPCVD), such that the layer of dielectric material is deposited at a temperature that is included in a range of approximately 700 degrees Celsius to approximately 900 degrees Celsius. In some implementations, the layer of dielectric material is deposited at a temperature that is greater than approximately 900 degrees Celsius.

As shown in FIG. 3E, an annealing operation may be performed on the semiconductor photonics device 100. The annealing operation may include a source/drain annealing operation that is performed to treat the source/drain regions 210 of the transistor structure 206 with heat to, for example, active dopants in the material of the source/drain regions 210, among other purposes. The source/drain annealing operation is also performed to treat the waveguide structure 110 in the photonics region 202 with heat to ensure that the waveguide structure 110 is formed to have little to no hydrogen content.

In some implementations, the source/drain annealing operation includes a nitrogen (N₂) anneal or nitrogen treatment operation that is performed to reduce the hydrogen concentration in the waveguide structure 110. The nitrogen anneal may be a rapid thermal annealing (RTA) operation, a furnace annealing operation, and/or another type of nitrogen-based annealing operation.

In some implementations, the source/drain annealing operation includes an in-situ steam generation (ISSG) annealing operation in which a water-based steam, or a combination of hydrogen (H₂) and oxygen (O₂) gasses are used to heat the source/drain regions 210 and the waveguide structure 110. The hydrogen gas and the oxygen gas oxidize the exposed surfaces of the waveguide structure 110 during the ISSG anneal, resulting in formation of the cladding layer 116. The use of the ISSG anneal results in formation of a high-quality silicon oxide (SiO₂) due to oxidization of the waveguide structure 110. The cladding layer 116 has a lower initial trap density and lower defect rate as a result of the ISSG anneal compared to high-temperature oxide (HTO)-based silicon dioxides. Moreover, the ISSG anneal results in lower sidewall roughness for the waveguide structure 110, which promotes a higher quality material interface between the cladding layer 116 and the waveguide structure 110 compared to HTO-based silicon dioxides.

In some implementations, the percentage of hydrogen by volume of the gas used in the ISSG annealing operation may be included in a range of approximately 2% to approximately 33%, with the remaining percentage being oxygen. However, other values and ranges are within the scope of the present disclosure. In some implementations, a total gas flow rate of hydrogen and oxygen in the ISSG annealing operation may be included in a range of approximately 100 standard cubic centimeters per minute (SCCM) to 4000 SCCM. However, other values and ranges are within the scope of the present disclosure.

The source/drain annealing operation breaks the silicon-hydrogen (Si—H) bonds and/or the nitrogen-hydrogen (N—H) bonds in the waveguide structure 110, thereby reducing the hydrogen content and concentration in the waveguide structure 110. In some implementations, the source/drain annealing operation is performed at a temperature that is greater than or approximately equal to 900 degrees Celsius. In some implementations, the source/drain annealing operation is performed at a temperature that is greater than or approximately equal to 1000 degrees Celsius. In some implementations, the source/drain annealing operation is performed at a temperature that is included in a range of approximately 900 degrees Celsius to approximately 1100 degrees Celsius. If the source/drain annealing operation is performed at a temperature that is less than approximately 900 degrees Celsius, the concentration of hydrogen in the waveguide structure 110 may be high, resulting in reduced optical performance for the waveguide structure 110. However, other values for the temperature of the source/drain annealing operation are within the scope of the present disclosure. In some implementations, the source/drain operation is performed for a time duration for approximately 5 seconds to approximately 20 seconds. However, other time durations for the source/drain annealing operation are within the scope of the present disclosure.

As indicated above, in some implementations, the waveguide structure 110 is a metal waveguide structure that includes one or more metal materials. In these implementations, the ISSG anneal includes oxidizing the exposed metal surfaces of the waveguide structure 110, resulting in formation of the cladding layer 116 that is a metal-oxide layer on the exposed surfaces of the waveguide structure 110. The cladding layer 116 (e.g., the metal-oxide layer) may include an oxide of the metal material of the waveguide structure 110. For example, if the waveguide structure 110 includes copper, the cladding layer 116 may include a copper oxide (CuOₓ) material.

As shown in FIG. 3F, the source/drain contacts 218 may be formed through the dielectric layer 104 to the source/drain regions 210 of the transistor structure 206 in the logic region 204. Moreover, the gate contact 222 may be formed over through the dielectric layer 104 to the gate structure 214.

To form the source/drain contacts 218 and the gate contact 222, recesses may be formed through the dielectric layer 104 to the source/drain regions 210 and to the gate structure 214. In some implementations, a pattern in a photoresist layer is used to etch the dielectric layer 104 to form the recesses. In these implementations, a deposition tool may be used to form the photoresist layer on the dielectric layer 104 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric layer 104 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 104 based on a pattern.

Prior to forming the source/drain contacts 218 in the recesses, metal silicide layers 304 may be formed on the exposed portions of the source/drain regions 210 in the recesses. In other words, the metal silicide layers 304 of the transistor structure 206 are formed after the source/drain annealing operation described above that was performed to achieve a low hydrogen concentration for the waveguide structure 110. As a result of the metal silicide layers 304 being formed in the recesses (e.g., as opposed to the metal silicide layers 304 being formed prior to formation of the dielectric layer 104), the metal silicide layers 304 cover only the exposed portions of the top surfaces of the source/drain regions 210 in the recesses.

The metal silicide layers 304 may include a titanium silicide (TiSi), a ruthenium silicide (RuSi), and/or another type of metal silicide material. The metal silicide layers 304 provide a transition between the semiconductor material of the source/drain regions 210 and the source/drain contacts 218, thereby enabling a low contact resistance to be achieved between the source/drain regions 210 and the source/drain contacts 218.

A deposition tool may be used to form a metal layer on the exposed portions of the source/drain regions 210 in the recesses. The deposition tool or an annealing tool may be used to perform an annealing operation to achieve salicidation of the metal layer and the semiconductor material of the source/drain regions 210, resulting in formation of the metal silicide layers 304. The salicidation may include the metal layer diffusing into the surface of the exposed portions of the source/drain regions 210.

The source/drain contacts 218 may be formed on the metal silicide layers 304 in the recesses. A deposition tool may be used to conformally deposit (e.g., using a CVD technique and/or an ALD technique) the liner layers 220 in the recesses, and a deposition tool may be used to deposit (e.g., using a PVD technique, a CVD technique, an ALD technique, an electroplating technique) the source/drain contacts 218 on the liner layers 220 in the recesses. Similarly, a deposition tool may be used to conformally deposit (e.g., using a CVD technique and/or an ALD technique) the liners 224 in the recesses above the gate structure 214, and a deposition tool may be used to deposit (e.g., using a PVD technique, a CVD technique, an ALD technique, an electroplating technique) the gate contact 222 on the liners 224 in the recess.

As shown in FIG. 3G, the dielectric layer 108 may be formed on the dielectric layer 104 and over the waveguide structure 110. A deposition tool may be used to deposit the dielectric layer 108 using a PVD technique, an ALD technique, a CVD technique, an oxidation technique, and/or another suitable deposition technique. The dielectric layer 108 may be deposited in one or more deposition operations. In some implementations, a planarization tool may be used to perform a planarization operation (e.g., a CMP operation) to planarize the dielectric layer 108 after the dielectric layer 108 is deposited.

As further shown in FIG. 3G, interconnect structures 226 may be formed in the dielectric layer 108 in the logic region 204. In some implementations, a plurality of layers of interconnect structure 226 may be formed sequentially such that the layers of interconnect structures 226 are stacked in the z-direction. For example, first recesses may be formed in the dielectric layer 108, and a first layer of interconnect structures 226 may be formed in the first recesses in the dielectric layer 108. Additional material of the dielectric layer 108 may be formed, second recesses may be formed in the dielectric layer 108, and a second layer of interconnect structures 226 may be formed in the second recesses. Additional dielectric layers 114 and interconnect structures 226 may be formed in a similar manner.

As shown in FIG. 3H, the dielectric layer 114 may be formed above and/or on the dielectric layer 108. A deposition tool may be used to deposit the dielectric layer 114 using a PVD technique, an ALD technique, a CVD technique, an oxidation technique, and/or another suitable deposition technique. The dielectric layer 114 may be deposited in one or more deposition operations. In some implementations, a planarization tool may be used to perform a planarization operation (e.g., a CMP operation) to planarize the dielectric layer 114 after the dielectric layer 114 is deposited. As further shown in FIG. 3H, additional interconnect structures 226 may be formed in the dielectric layer 114 in a similar manner as described above in connection with FIG. 3G.

As indicated above, FIGS. 3A-3H are provided as an example. Other examples may differ from what is described with regard to FIGS. 3A-3H.

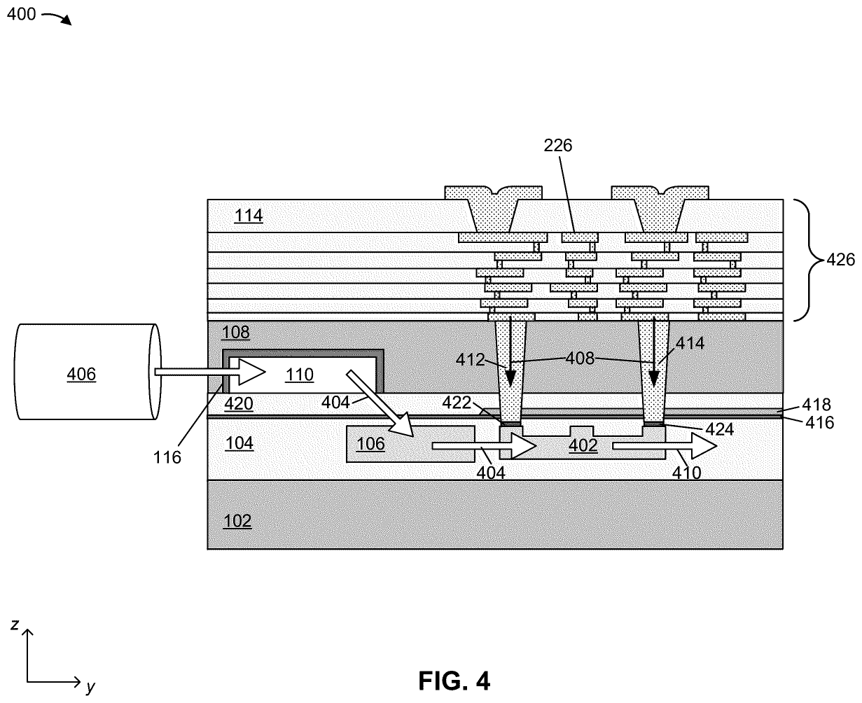

FIG. 4 is a diagram of an example of a semiconductor photonics device 400 described herein. The semiconductor photonics device 400 may include a photonic integrated circuit that includes a similar arrangement of structures and layers as the semiconductor photonics device 100, such as a semiconductor waveguide structure 106 and a waveguide structure 110 above the semiconductor waveguide structure 106, and a cladding layer 116 on the waveguide structure 110. As further shown in FIG. 4, the semiconductor photonics device 400 includes one or more additional semiconductor photonics components, such as an optical modulator structure 402. The optical modulator structure 402 may be formed from the same semiconductor layer as the semiconductor waveguide structure 106.

The optical modulator structure 402 may be located laterally adjacent to the semiconductor waveguide structure 106 in the y-direction in the semiconductor photonics device 400. The optical modulator structure 402 may include a micro-ring modulator (MRM), a Mach-Zender modulator (MZM), and/or another type of optical modulator that includes a semiconductor waveguide structure that is electrically coupled to a set of electrical contacts. The optical modulator structure 402 may be configured to encode data onto an input optical signal 404 for optical communication.

The input optical signal 404 may be transferred from the waveguide structure 110 to the semiconductor waveguide structure 106, and from the semiconductor waveguide structure 106 to the optical modulator structure 402. The waveguide structure 110 may receive the input optical signal 404 from an input optical fiber 406 or another type of external optical connection. The input optical fiber 406 may be located at a side of the semiconductor photonics device 400 (e.g., as shown in the example in FIG. 4), may be located at a top of the semiconductor photonics device 400, and/or may be located at another location.

The optical modulator structure 402 may modulate the input optical signal 404 based on an input electrical signal 408 to generate a modulated optical signal 410. The optical modulator structure 402 may modulate the amplitude of the input optical signal 404, the phase of the input optical signal 404, the frequency of the input optical signal 404, and/or another property of the input optical signal 404 based on the input electrical signal 408. The optical modulator structure 402 may include a P—N junction that is formed by different doped regions of semiconductor material. The semiconductor material may include silicon (Si), germanium (Ge), silicon germanium (SiGe), and/or another semiconductor material. The semiconductor material may be doped with p-type dopants to form one or more p-type regions, and may be doped with n-type dopants to form one or more n-type regions, such that a P—N junction is formed. The p-type dopant(s) may include p-type ions of a p-type material (e.g., boron (B) or germanium (Ge), among other examples). The n-type dopant(s) may include n-type ions of an n-type material (e.g., phosphorous (P) or arsenic (As), among other examples).

The input electrical signal 408 may be applied to the optical modulator structure 402 through contacts 412 and/or 414 of the optical modulator structure 402. The contacts 412 and/or 414 may include one or more types of doped semiconductor materials. The contacts 412 and 414 may each include one or more electrically conductive materials, such as tungsten (W), cobalt (Co), ruthenium (Ru), titanium (Ti), aluminum (Al), copper (Cu), and/or gold (Au), among other examples of conductive materials.

When the input electrical signal 408 is applied to the P—N junction of the optical modulator structure 402, a junction depletion width of the P—N junction is modified. This results in changes in concentrations of electrons and holes within the optical modulator structure 402. The changes in concentrations of electrons and holes may lead to changes of the effective refractive index of the optical modulator structure 402, which may modulate the input optical signal 404 (e.g., the phase and/or another property of the input optical signal 404) to generate the modulated optical signal 410.

Alternatively, the optical modulator structure 402 may include a thermo-optic modulator that modulates the input optical signals 404 based on changes in temperature in the semiconductor waveguide structure of the optical modulator structure 402. In these implementations, the contacts 412 and 414 of the optical modulator structure 402 may be coupled to a heater structure that generates heat that is provided to the semiconductor waveguide structure of the optical modulator structure 402.

As further shown in FIG. 4, one or more additional dielectric layers may be included between the dielectric layer 104 and the dielectric layer 108 of the semiconductor photonics device 400. For example, a remote plasma oxide (RPO) layer 416 may be included on the dielectric layer 104. As another example, a contact etch stop layer (CESL) 418 may be included on the RPO layer 416. As another example, an interlayer oxide 420 may be included on the RPO layer 416 and/or on the CESL 418.

The CESL 418 may be located above the optical modulator structure 402. The CESL 418 may be omitted from above the semiconductor waveguide structure 106 so that the CESL 418 does not interfere with the transfer of input optical signals 404 between the waveguide structure 110 and the semiconductor waveguide structure 106. The CESL 418 may include a silicon nitride (SiₓN_{y} such as Si₃N₄), silicon oxynitride (SiON), aluminum oxide (AlₓO_{y} such as Al₂O₃), and/or another suitable material.

The CESL 418 may be included to facilitate precise formation of recesses for the contacts 412 and 414. In particular, the CESL 418 may include one or more dielectric materials to provide etch selectivity relative to the dielectric layers 104 and 108, to enable etching of the dielectric layers 104 and 108 when forming the recesses to stop on the CESL 418 (which prevents etching into the optical modulator structure 402).

Metal silicide layers 422 and 424 may be included between the optical modulator structure 402 and the contacts 412 and 414, respectively. The metal silicide layers 422 and 424 may each include a titanium silicide (TiSi), a ruthenium silicide (RuSi), and/or another type of metal silicide material. The metal silicide layers 422 and 424 provide a transition between the semiconductor material of the optical modulator structure 402 and the contacts 412 and 414, thereby enabling a low contact resistance to be achieved between the optical modulator structure 402 and the contacts 412 and 414.

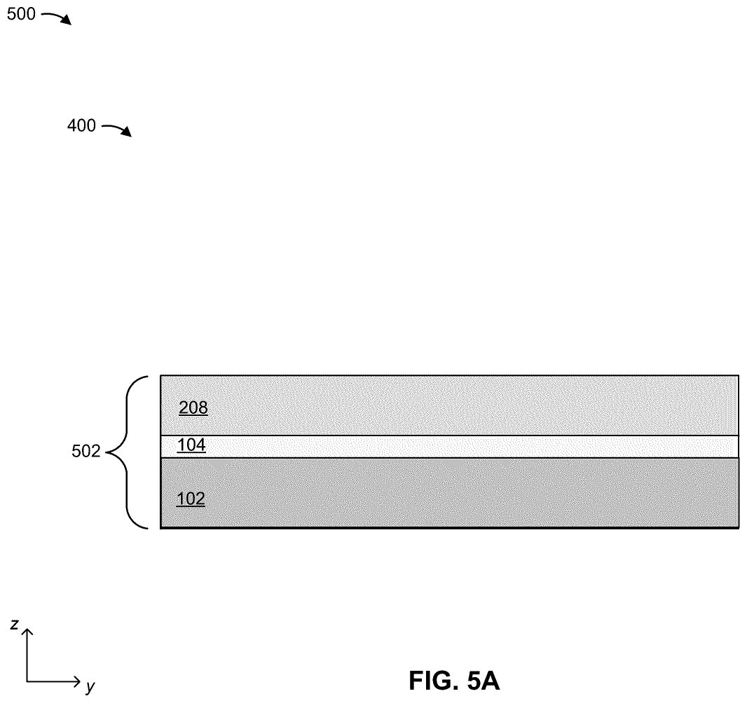

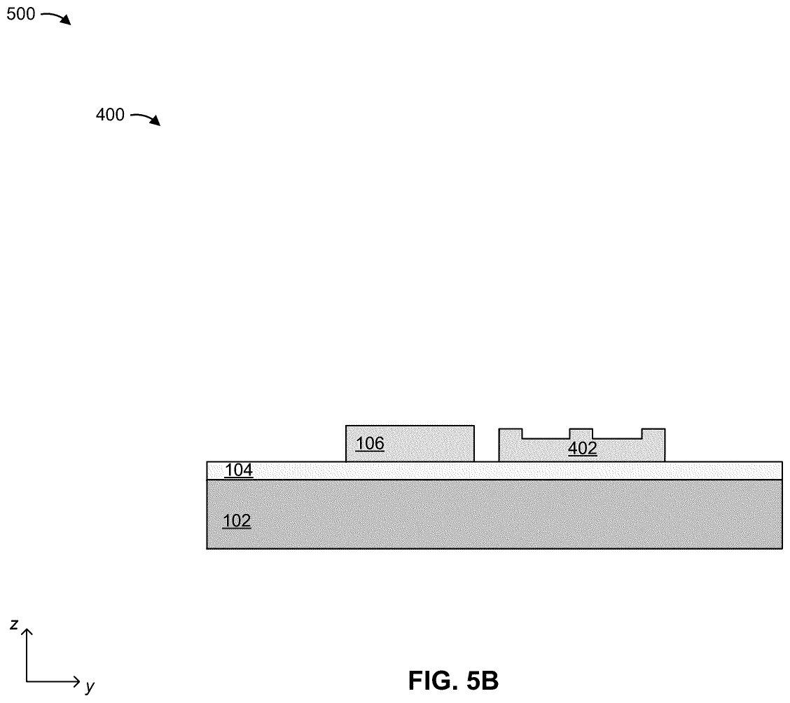

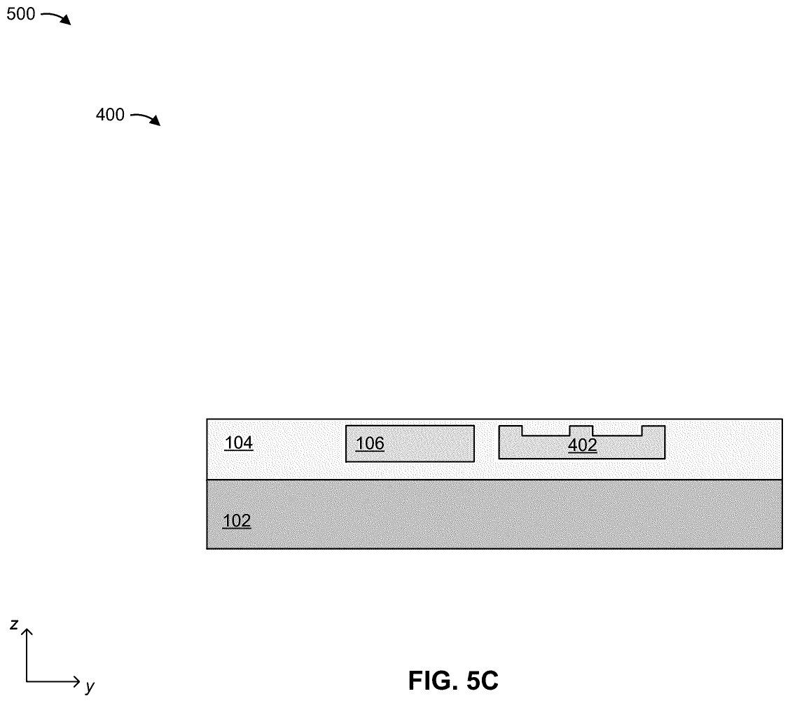

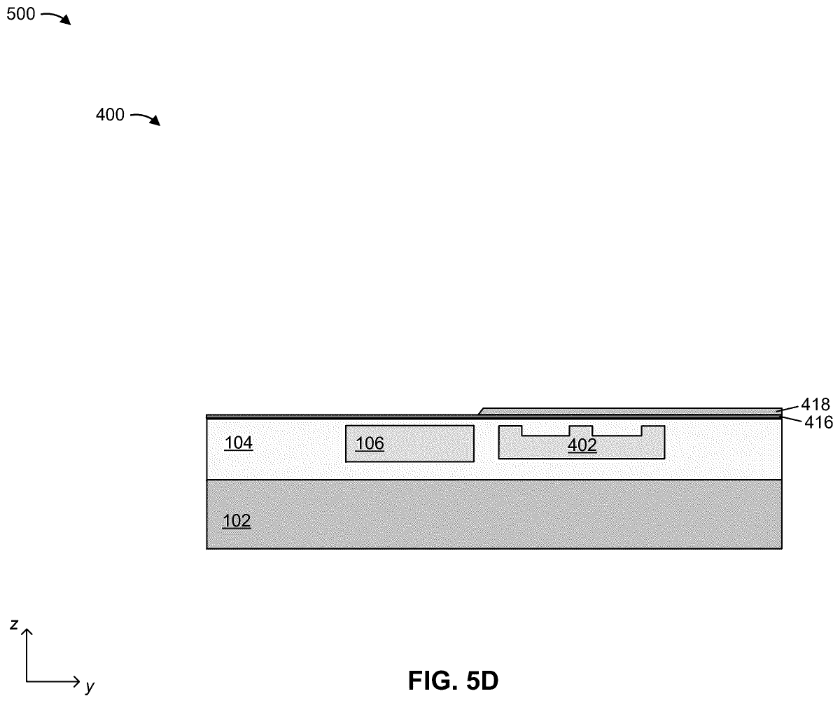

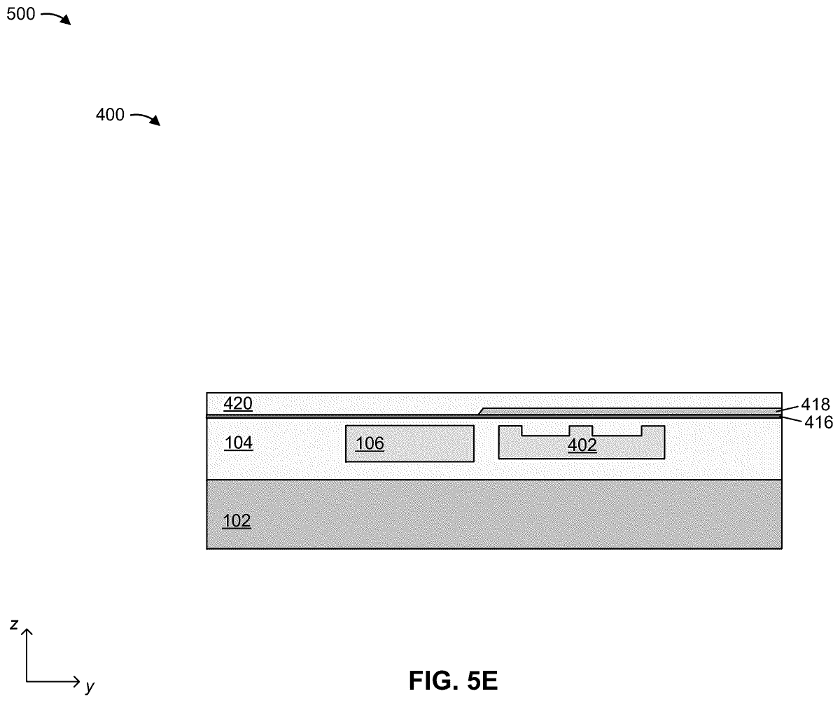

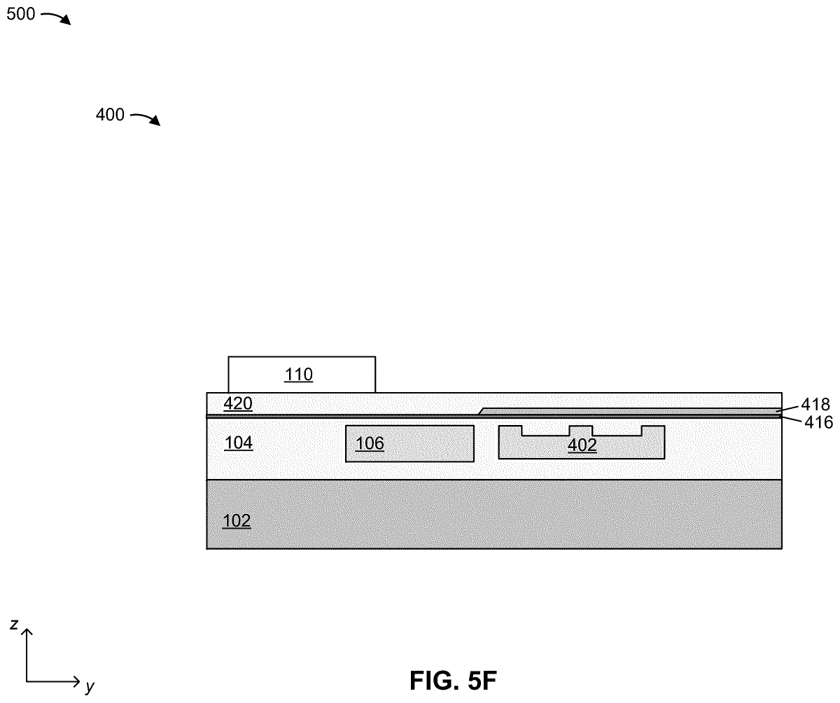

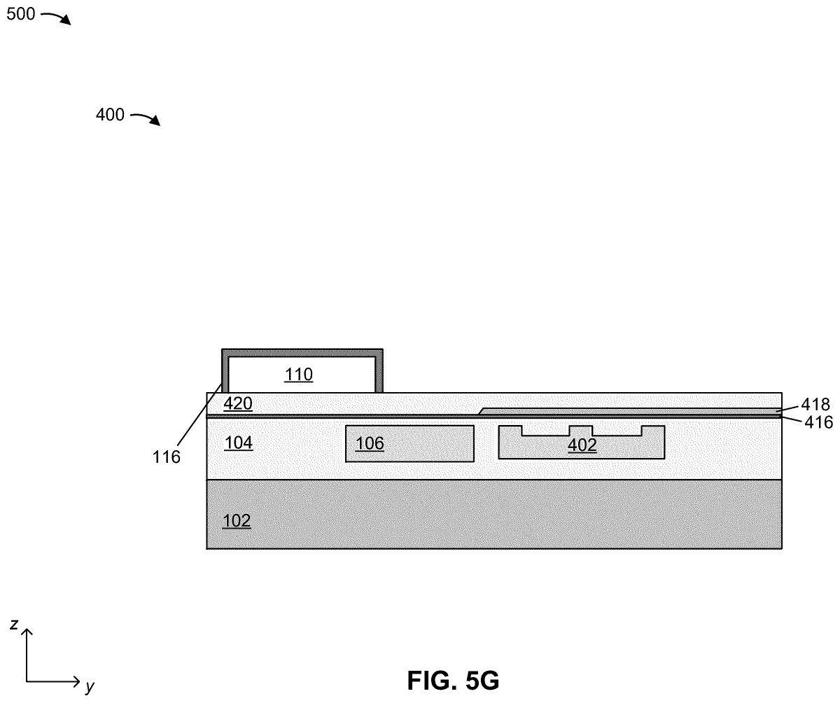

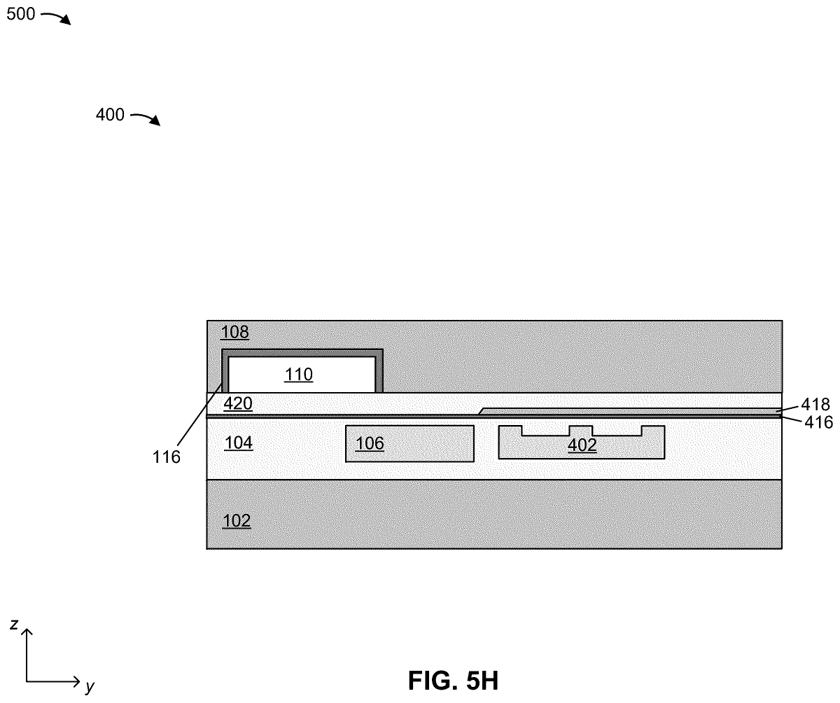

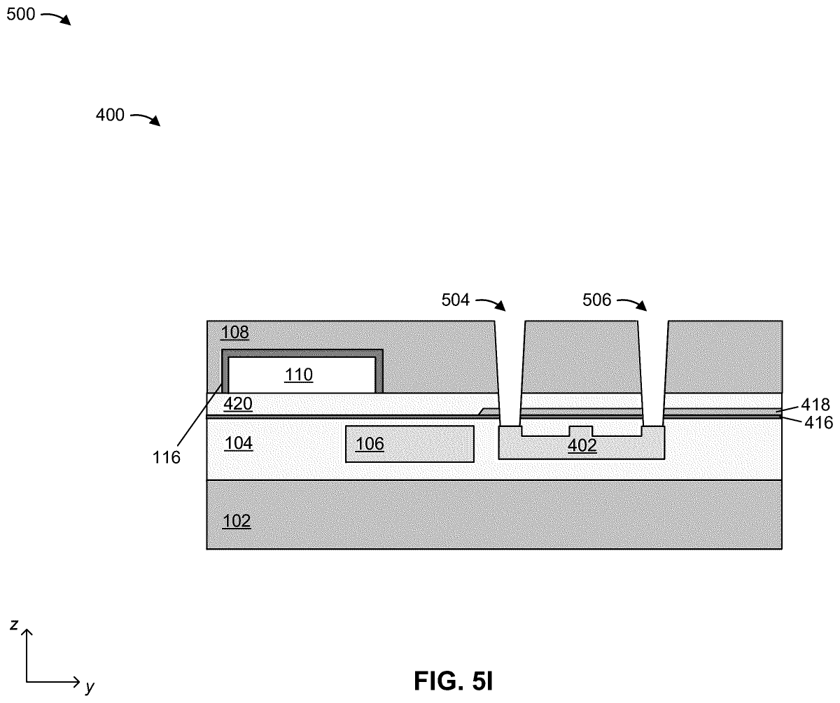

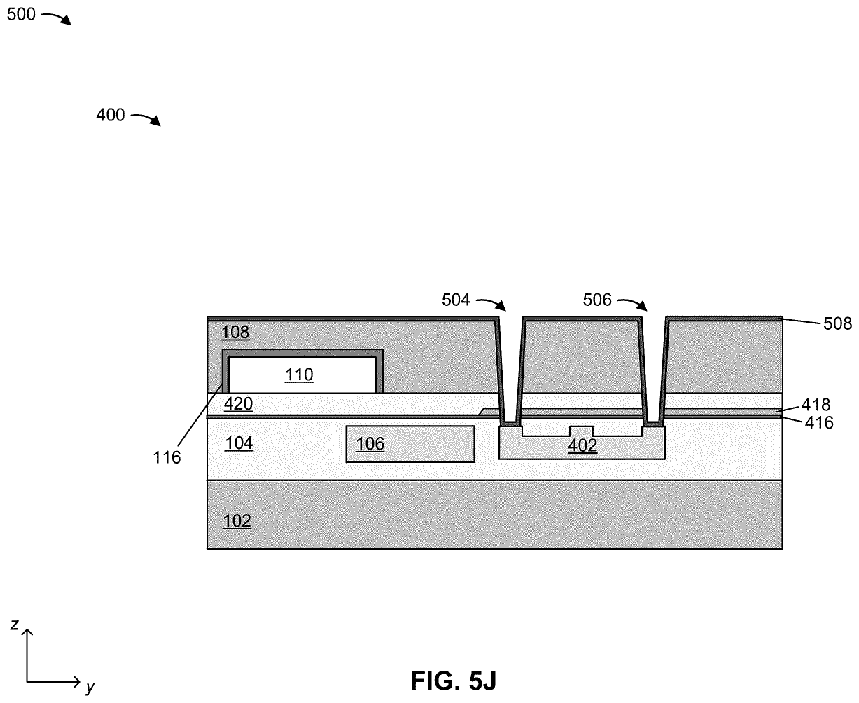

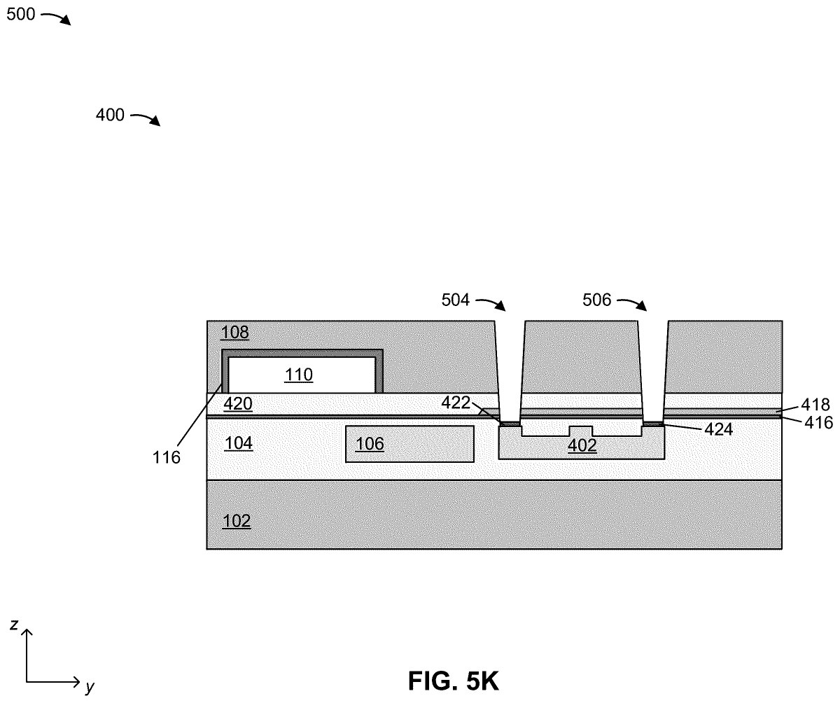

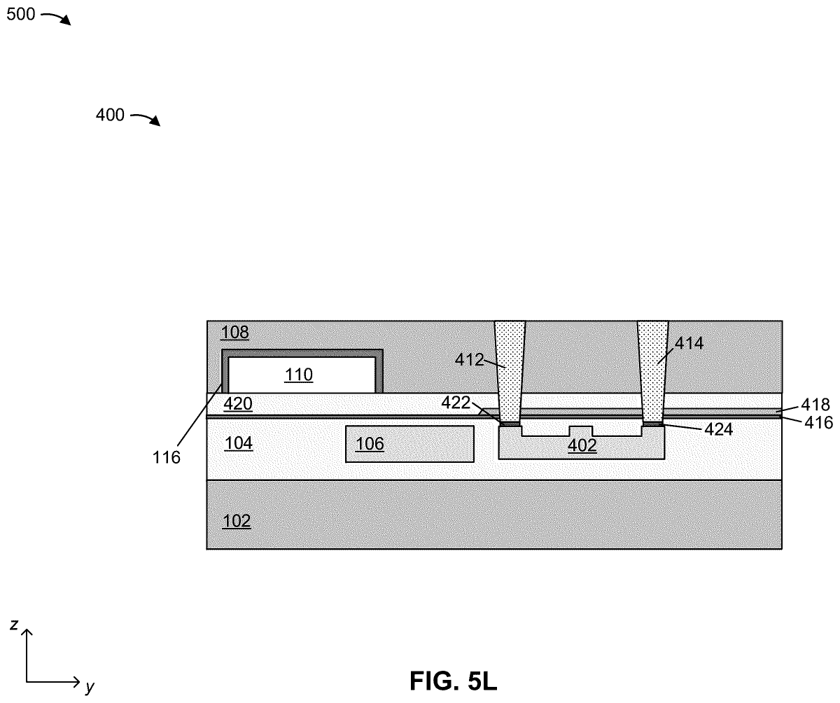

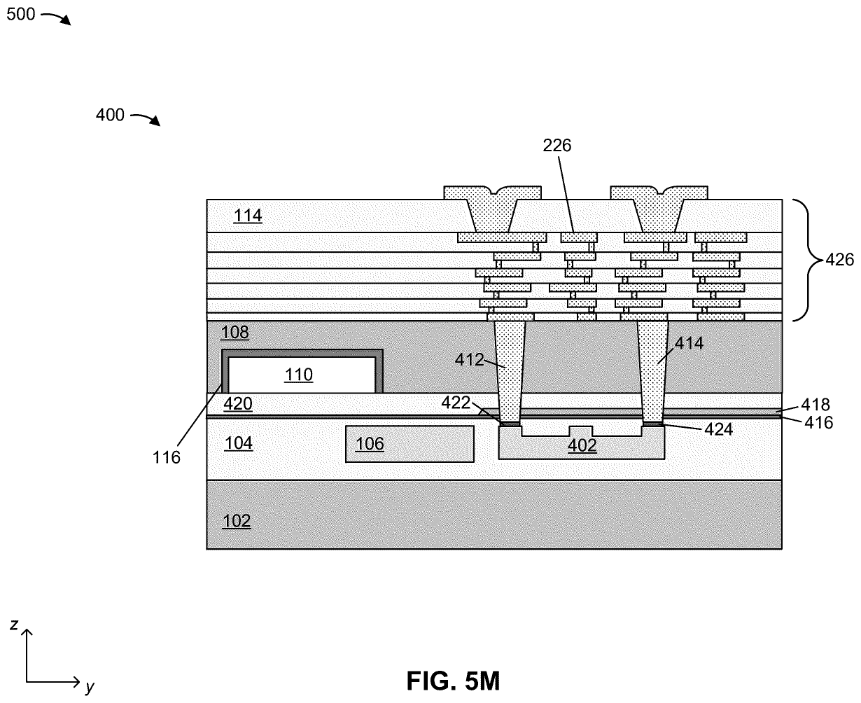

As described herein, such as in connection with FIGS. 5A-5M, the waveguide structure 110 may be treated with high-temperature processing prior to formation of the metal silicide layers 422 and 424, which prevents, minimizes, and/or reduces the likelihood of damage and/or degradation to the metal silicide layers 422 and 424. If the waveguide structure 110 were treated with high-temperature processing after formation of the metal silicide layers 422 and 424, the high-temperature process techniques used to achieve a low hydrogen concentration in the waveguide structure 110 might otherwise result in damage to the metal silicide layers 422 and 424. Accordingly, the high-temperature process techniques are used for forming and/or treating the waveguide structure 110 prior to formation of the metal silicide layers 422 and 424 to minimize the likelihood of and/or prevent further (unwanted) diffusion of metal atoms of the metal layer into the semiconductor structure of the optical modulator structure 402 that might otherwise negatively alter the electrical properties of the optical modulator structure 402. In this way, the high-temperature process techniques are used for forming and/or treating the waveguide structure 110 prior to formation of the metal silicide layers 422 and 424 enables a low contact resistance to be achieved for the optical modulator structure 402 while enabling a low hydrogen concentration to be achieved for the waveguide structure 110.

Since the metal silicide layers 422 and 424 are formed after the high-temperature process techniques that are used for forming and/or treating the waveguide structure 110, the metal silicide layers 422 and 424 may be formed in recesses in which the contacts 412 and 414 are formed. Thus, the metal silicide layers 422 and 424 cover only the portions of the top surfaces of the optical modulator structure 402 that are exposed in the recesses in which the contacts 412 and 414 are formed.

An interconnect layer 426 may be included above the dielectric layer 108. The interconnect layer 426 may include a backend region or BEOL region of the semiconductor photonics device 400. The interconnect layer 426 may include one or more dielectric layers 114 and one or more interconnect structures 226 in the one or more dielectric layers 114. The contacts 412 and 414 may be electrically coupled and/or physically coupled with one or more interconnect structures 226 in the one or more dielectric layers 114 of the interconnect layer 426. The input electrical signals 408 may be provided to the optical modulator structure 402 through the interconnect structures 226. The interconnect structures 226 correspond to circuitry that enables signals and/or power to be provided to and/or from the optical modulator structure 402 and/or other devices in the semiconductor photonics device 400.

As indicated above, FIG. 4 is provided as an example. Other examples may differ from what is described with regard to FIG. 4.

FIGS. 5A-5M are diagrams of an example implementation 500 of forming the semiconductor photonics device 400 described herein. In particular, the example implementation 500 includes an example of forming the waveguide structure 110 and treating the waveguide structure 110 with high-temperature processing prior to forming the metal silicide layers 422 and 424 of the optical modulator structure 402. This limits the exposure of the metal silicide layers 422 and 424 to high temperatures that might otherwise damage and/or degrade the performance of the optical modulator structure 402. In some implementations, one or more of the operations described in connection with FIGS. 5A-5M may be performed using one or more semiconductor processing tools, such as a deposition tool, an exposure tool (e.g., a lithography tool), a developer tool, an etch tool, a planarization tool (e.g., a CMP tool, a wafer grinding tool), an ion implantation tool, an annealing tool, and/or a wafer/die transport tool, among other examples.

As shown in FIG. 5A, a substrate 502 of the semiconductor photonics device 400 may be provided. The substrate 502 may include an SOI substrate that includes the substrate layer 102 (e.g., a silicon (Si) substrate and/or another type of semiconductor substrate), a portion of the dielectric layer 104 (e.g., a BOX layer and/or another type of insulator layer) over and/or on the substrate layer 102, and the semiconductor layer 208 (e.g., a silicon (Si) layer and/or another type of semiconductor layer) over and/or on the portion of the dielectric layer 104.

As shown in FIG. 5B, the semiconductor waveguide structure 106 and the optical modulator structure 402 may be formed from the semiconductor layer 208 above the dielectric layer 104. In some implementations, one or more transistor structures 206 may be formed in and/or on the semiconductor layer 208.

In some implementations, a hard mask layer may be formed over and/or on the semiconductor layer 208, and a pattern in the hard mask layer may be used to etch the semiconductor layer 208 to form the semiconductor waveguide structure 106 and the optical modulator structure 402. Deposition tools may be used to deposit the hard mask layer on the semiconductor layer 208 (e.g., using a CVD technique, a PVD technique, and/or another type of deposition technique) and a photoresist layer on the hard mask layer (e.g., using a spin-coating technique and/or another type of deposition technique). The hard mask layer may include a silicon nitride (SiₓN_{y} such as Si₃N₄) material or another hard mask material. The photoresist layer may include a light-sensitive material that can be patterned using an exposure tool such as a DUV lithography tool and/or an EUV lithography tool, among other examples.

An exposure tool may be used to expose the photoresist layer to a radiation source to form a pattern in the photoresist layer. A developer tool may be used to develop and remove portions of the photoresist layer to expose the pattern. An etch tool may be used to etch the hard mask layer to transfer the pattern from the photoresist layer to the hard mask layer. An etch tool may then be used to etch the semiconductor layer 208 based on the pattern in the hard mask layer to remove material from the semiconductor layer 208 to form the semiconductor waveguide structure 106 and the optical modulator structure 402. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique).

As shown in FIG. 5C, additional material of the dielectric layer 104 may be deposited around and/or on the semiconductor waveguide structure 106 and the optical modulator structure 402 such that the semiconductor waveguide structure 106 and the optical modulator structure 402 are encapsulated in the dielectric layer 104. The additional material may be referred to as a shallow trench isolation (STI) portion of the dielectric layer 104. A deposition tool may be used to deposit the additional material of the dielectric layer 104 using a CVD technique, a PVD technique, an oxidation technique, and/or another type of deposition technique. In some implementations, a planarization tool is used to perform a planarization operation (e.g., a CMP operation) to planarize the dielectric layer 104 after the additional material of the dielectric layer 104 is deposited.

A shown in FIG. 5D, the RPO layer 416 may be formed on the dielectric layer 104, and the CESL 418 may be formed on the RPO layer 416. A deposition tool may be used to deposit the RPO layer 416 using a CVD technique, a PVD technique, an oxidation technique, and/or another type of deposition technique. In some implementations, a planarization tool is used to perform a planarization operation (e.g., a CMP operation) to planarize the RPO layer 416 after the additional material of the RPO layer 416 is deposited.

A deposition tool may be used to deposit the CESL 418 using a CVD technique, a PVD technique, an oxidation technique, and/or another type of deposition technique. In some implementations, a planarization tool is used to perform a planarization operation (e.g., a CMP operation) to planarize the CESL 418 after the additional material of the CESL 418 is deposited.

In some implementations, the CESL 418 is formed above the semiconductor waveguide structure 106 and above the optical modulator structure 402. In these implementations, the CESL 418 may be patterned and etched using etch tool to remove the portion of the CESL 418 above the semiconductor waveguide structure 106. In this way, the CESL 418 remains above the optical modulator structure 402 and is not included above the semiconductor waveguide structure 106.

A shown in FIG. 5E, the interlayer oxide 420 may be formed on the RPO layer 416 and on the CESL 418. A deposition tool may be used to deposit the interlayer oxide 420 using a CVD technique, a PVD technique, an oxidation technique, and/or another type of deposition technique. In some implementations, a planarization tool is used to perform a planarization operation (e.g., a CMP operation) to planarize the interlayer oxide 420 after the additional material of the interlayer oxide 420 is deposited.

As shown in FIGS. 5F and 5G, the waveguide structure 110 may be formed on the interlayer oxide 420, and an annealing operation (e.g., a source/drain annealing operation) may be performed on the waveguide structure 110 in a similar manner as described in connection with FIGS. 3D and 3E. The annealing operation results in oxidation of the exposed surfaces of the waveguide structure 110, which causes the cladding layer 116 to be formed on the exposed surfaces of the waveguide structure 110. The annealing operation is performed prior to formation of the metal silicide layers 422 and 424 of the optical modulator structure 402, and prior to formation of the metal silicide layers 304 of the transistor structures 206 of the semiconductor photonics device 100.

As shown in FIG. 5H, the dielectric layer 108 may be formed on the interlayer oxide 420 and over the waveguide structure 110. A deposition tool may be used to deposit the dielectric layer 108 using a PVD technique, an ALD technique, a CVD technique, an oxidation technique, and/or another suitable deposition technique. The dielectric layer 108 may be deposited in one or more deposition operations. In some implementations, a planarization tool may be used to perform a planarization operation (e.g., a CMP operation) to planarize the dielectric layer 108 after the dielectric layer 108 is deposited.

As shown in FIG. 5I, recesses 504 and 506 may be formed over portions of the optical modulator structure 402 such that the portions of the optical modulator structure 402 are exposed through the recesses 504 and 506. The recesses 504 and 506 may extend through the dielectric layer 108, through the interlayer oxide 420, through the CESL 418, and/or through the RPO layer 416 to the optical modulator structure 402.

In some implementations, a pattern in a photoresist layer is used to etch the dielectric layer 108, the interlayer oxide 420, the CESL 418, and/or the RPO layer 416 to form the recesses 504 and 506. In these implementations, a deposition tool may be used to form the photoresist layer on the dielectric layer 108 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric layer 108, the interlayer oxide 420, the CESL 418, and/or the RPO layer 416 based on the pattern to form the recesses 504 and 506. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recesses 504 and 506 based on a pattern.

As shown in FIGS. 5J and 5K, the metal silicide layers 422 and 424 may be respectively formed in the recesses 504 and 506 prior to respectively forming the contacts 412 and 414 in the recesses 504 and 506. In other words, the metal silicide layers 422 and 424 of the optical modulator structure are formed after the annealing operation described above that was performed to achieve a low hydrogen concentration for the waveguide structure 110. As a result of the metal silicide layers 422 and 424 being formed in the recesses 504 and 506 (e.g., as opposed to the metal silicide layers 422 and 424 being formed prior to formation of the dielectric layer 108), the metal silicide layers 422 and 424 cover only the exposed portions of the top surfaces of the optical modulator structure 402 in the recesses 504 and 506.

As shown in FIG. 5J, to form the metal silicide layers 422 and 424, a deposition tool may be used to form a metal layer 508 on the sidewalls and on the bottom surfaces of the recesses 504 and 506. The deposition tool or an annealing tool may be used to perform an annealing operation to achieve salicidation of the metal layer 508 and the semiconductor material of the optical modulator structure 402, resulting in formation of the metal silicide layers 422 and 424. Unreacted material of the metal layer 508 on the sidewalls of the recesses 504 and 506, and on the top surface of the dielectric layer 108, may be subsequently removed.

As shown in FIG. 5L the contacts 412 and 414 may be respectively formed on the metal silicide layers 422 and 424 in the recesses 504 and 506. In some implementations, a deposition tool may be used to conformally deposit (e.g., using a CVD technique and/or an ALD technique) liners in the recesses 504 and 506, and a deposition tool may be used to deposit (e.g., using a PVD technique, a CVD technique, an ALD technique, an electroplating technique) the contacts 412 and 414 in the recesses 504 and 506.

As shown in FIG. 5M, the dielectric layers 114 and the interconnect structures 226 of the interconnect layer 426 may be formed above and/or on the dielectric layer 108 (e.g., after the contacts 412 and 414 are formed). A deposition tool may be used to deposit the dielectric layers 114 using a PVD technique, an ALD technique, a CVD technique, an oxidation technique, and/or another suitable deposition technique. A deposition tool may be used to deposit the interconnect structures 226 using a PVD technique, an ALD technique, a CVD technique, an electroplating technique, and/or another suitable deposition technique.

In some implementations, the dielectric layers 114 and the interconnect structures 226 of the interconnect layer 426 are formed sequentially. For example, a first dielectric layer 114 may be formed, recesses may be formed in the first dielectric layer 114, and a first layer of interconnect structures 226 may be formed in the recesses in the first dielectric layer 114. A second dielectric layer 114 may be formed on the first dielectric layer 114, recesses may be formed in the second dielectric layer 114, and a second layer of interconnect structures 226 may be formed in the recesses in the second dielectric layer 114. Additional dielectric layers 114 and interconnect structures 226 may be formed in a similar manner.

As indicated above, FIGS. 5A-5M are provided as an example. Other examples may differ from what is described with regard to FIGS. 5A-5M.

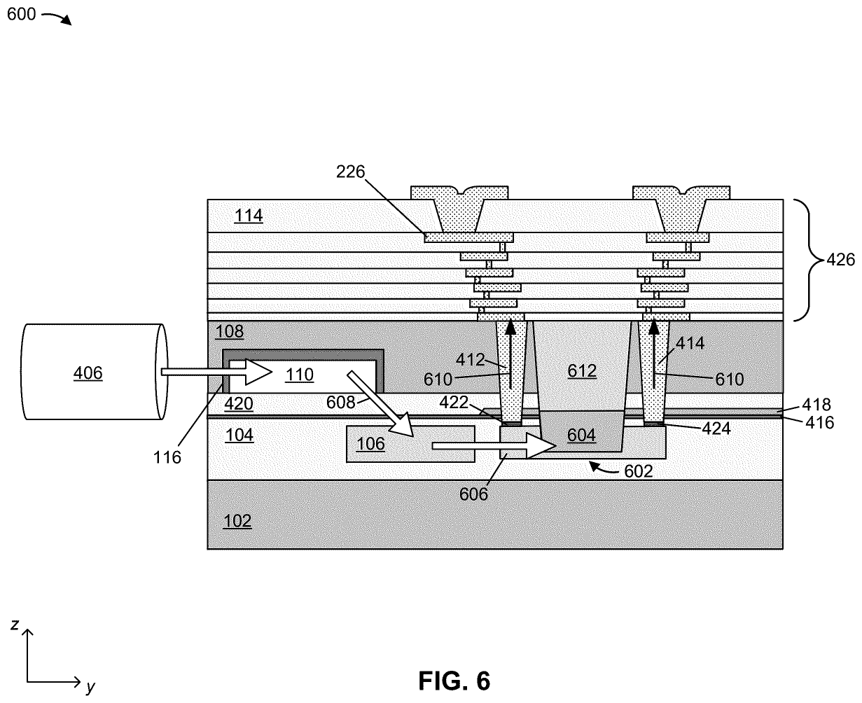

FIG. 6 is a diagram of an example of a semiconductor photonics device 600 described herein. The semiconductor photonics device 600 may include a photonic integrated circuit that includes a similar arrangement of structures and layers as the semiconductor photonics device 400, such as a semiconductor waveguide structure 106, a waveguide structure 110 above the semiconductor waveguide structure 106, and a cladding layer 116 on the waveguide structure 110 that results from the exposed surfaces of the waveguide structure 110 being oxidized from high-temperature processing. However, the semiconductor photonics device 600 includes a photodetector structure 602 instead of (or in addition to) an optical modulator structure 402. Portions of the photodetector structure 602 may be formed from the same semiconductor layer as the semiconductor waveguide structure 106, such as in the semiconductor layer 208 of the semiconductor photonics device 600.

The photodetector structure 602 includes a semiconductor photonics component that is configured to generate a current, a voltage, and/or another type of electrical output signal based on absorbed photons of light from input optical signals. The photodetector structure 602 may include an absorption region 604 that converts photons to electrodes, and a semiconductor base 606 that includes terminals that correspond to collection regions for the electrons generated by the absorption region 604.

The absorption region 604 may include an epitaxially grown region of semiconductor material that includes germanium (Ge), germanium tin (GeSn), silicon germanium (SiGe), indium gallium arsenide (InGaAs), and/or gallium arsenide (GaAs), among other examples. The absorption region 604 may be configured to absorb photons of an input optical signals 608. The input optical signal 608 may be received from the input optical fiber 406, and may be transferred through the waveguide structure 110 and the semiconductor waveguide structure 106 to the absorption region 604 of the photodetector structure 602. The photons interact with electron-hole pairs in the absorption region 604. The interaction causes electrons and holes to be separated and to migrate toward opposing terminals (e.g., opposing collection regions) of the semiconductor base 606, resulting in the generation of an electric field (e.g., a built-in electric field) that is provided to the contacts 412 and 414 as an output electrical signal 610. In some implementations, the photodetector structure 602 includes a semiconductor waveguide structure coupled to the absorption region 604 to direct the input optical signals 608 toward the absorption region 604.

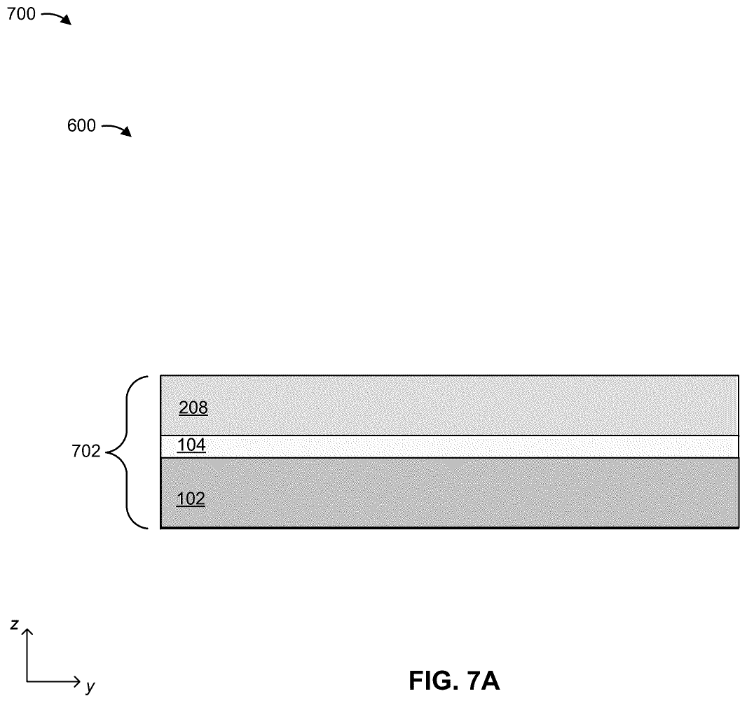

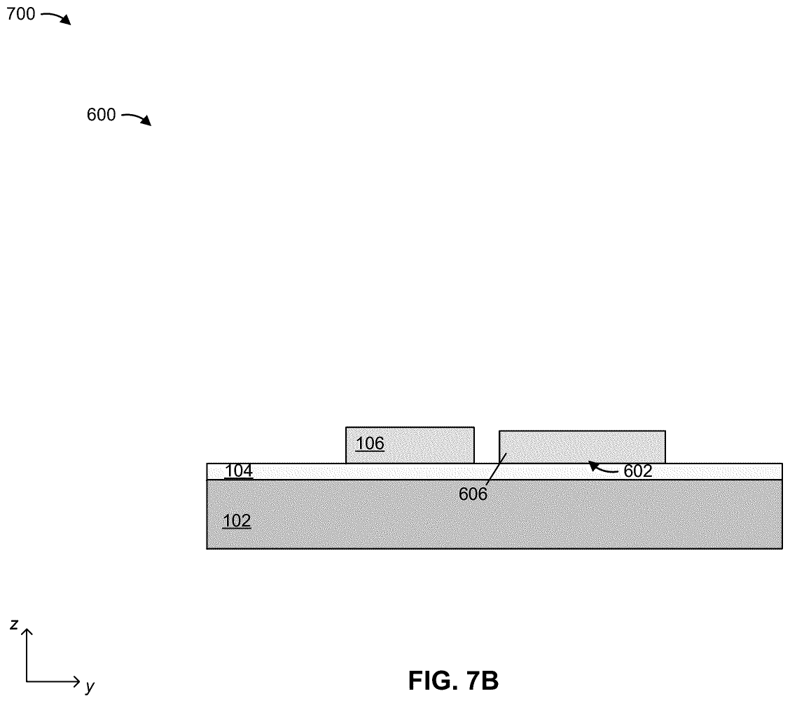

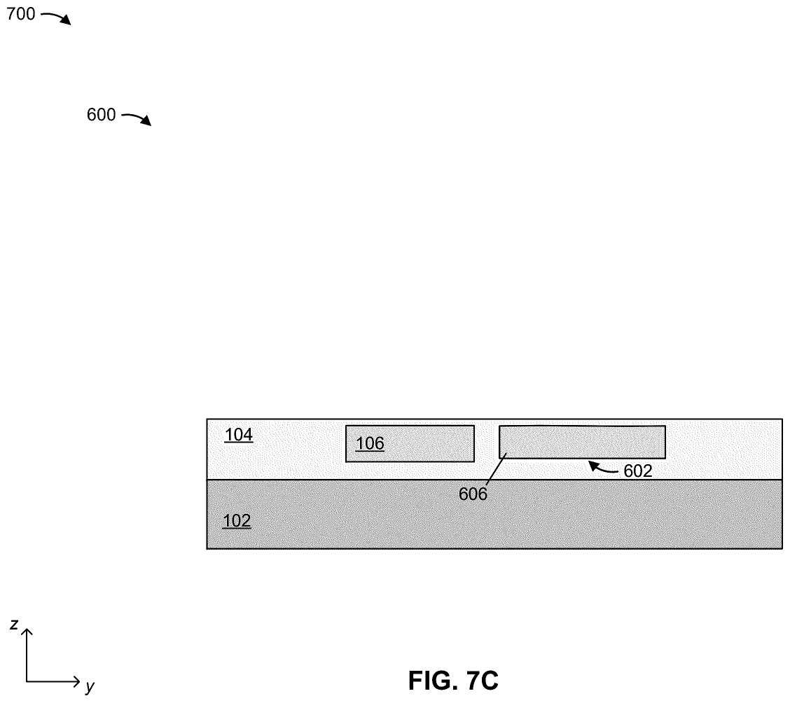

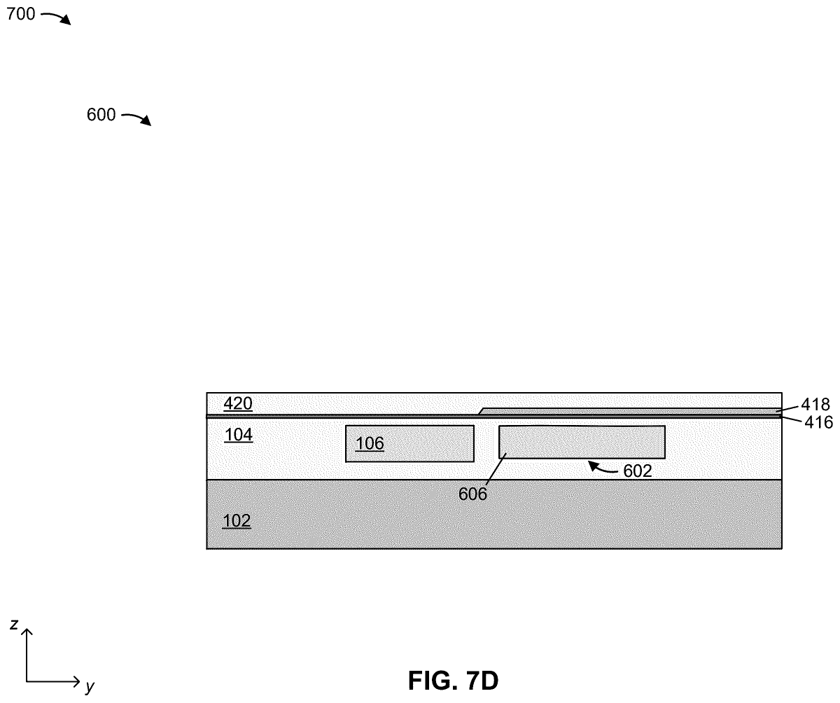

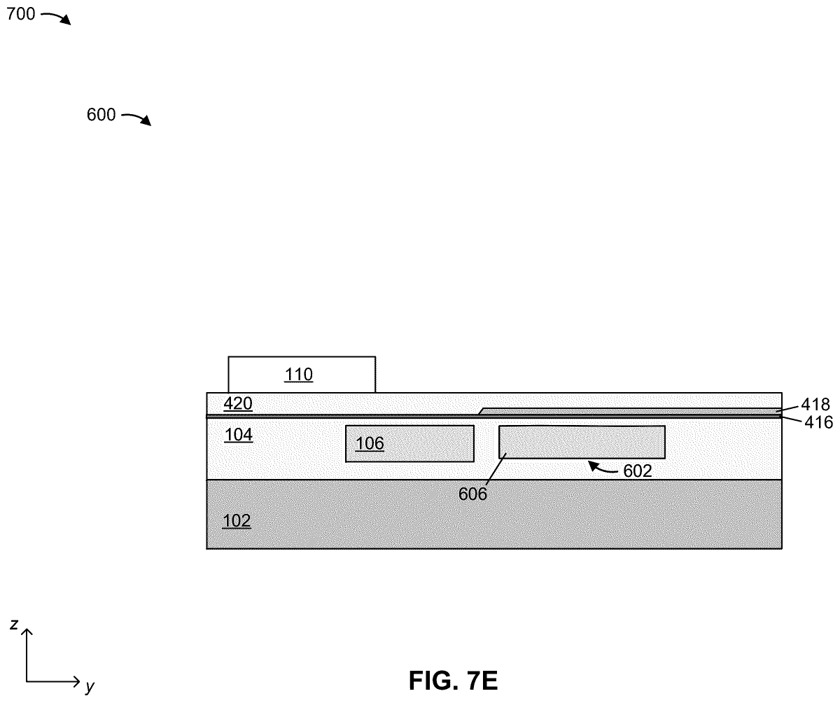

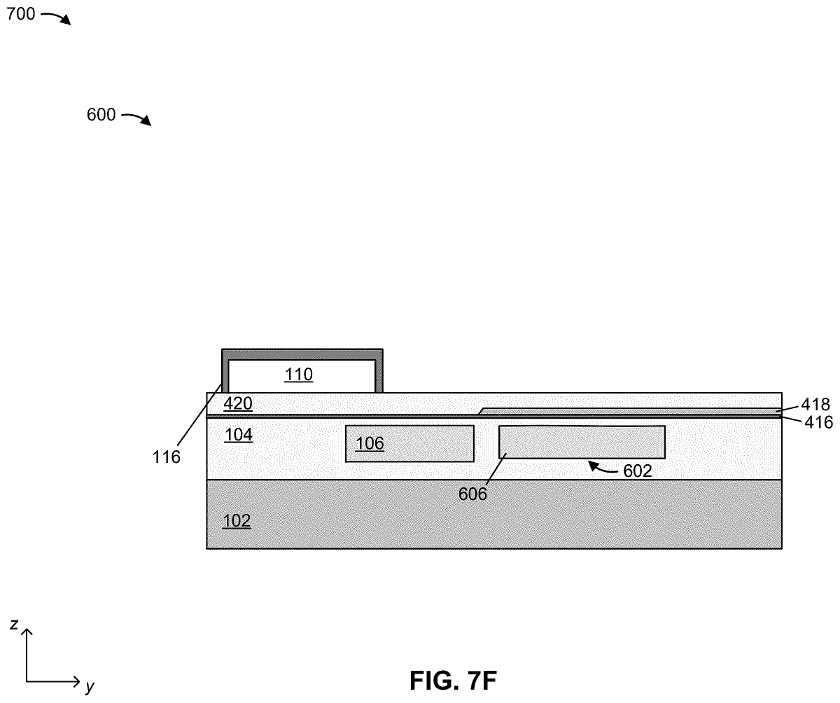

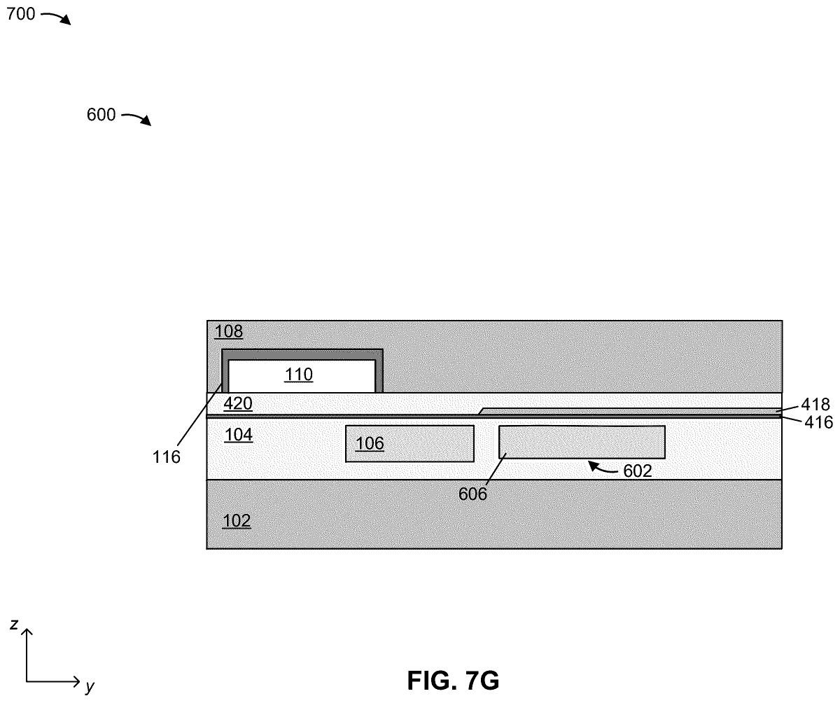

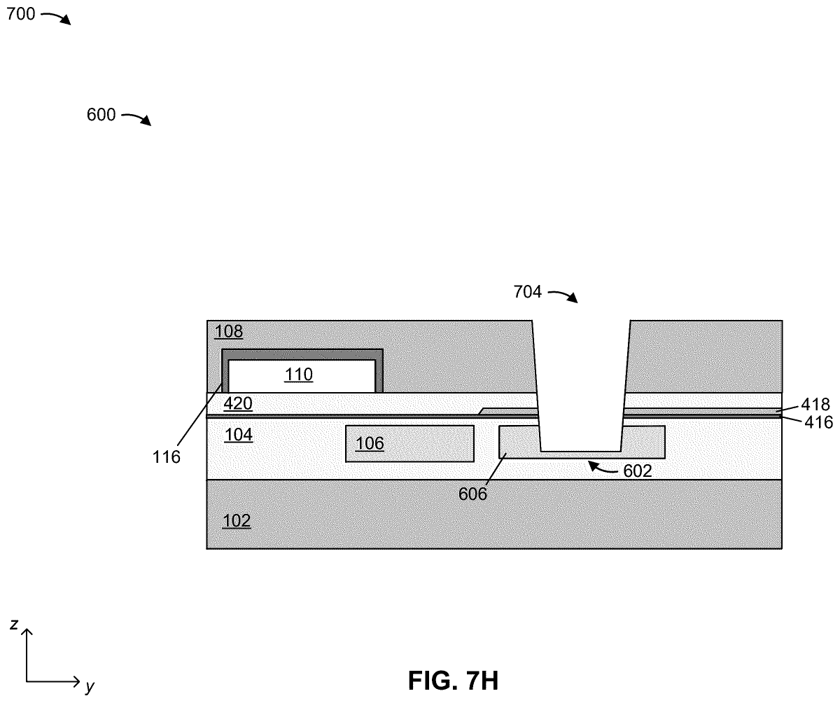

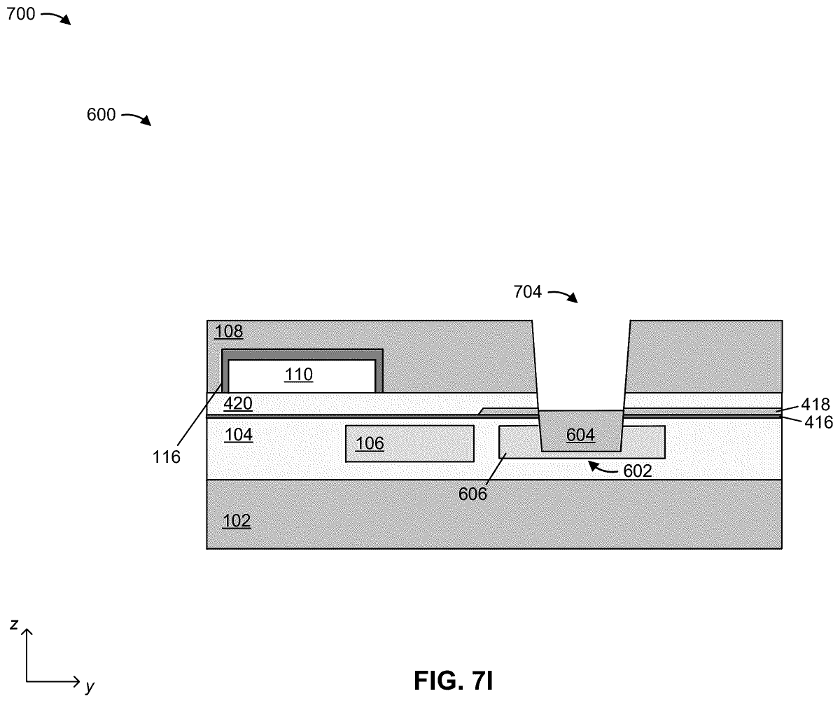

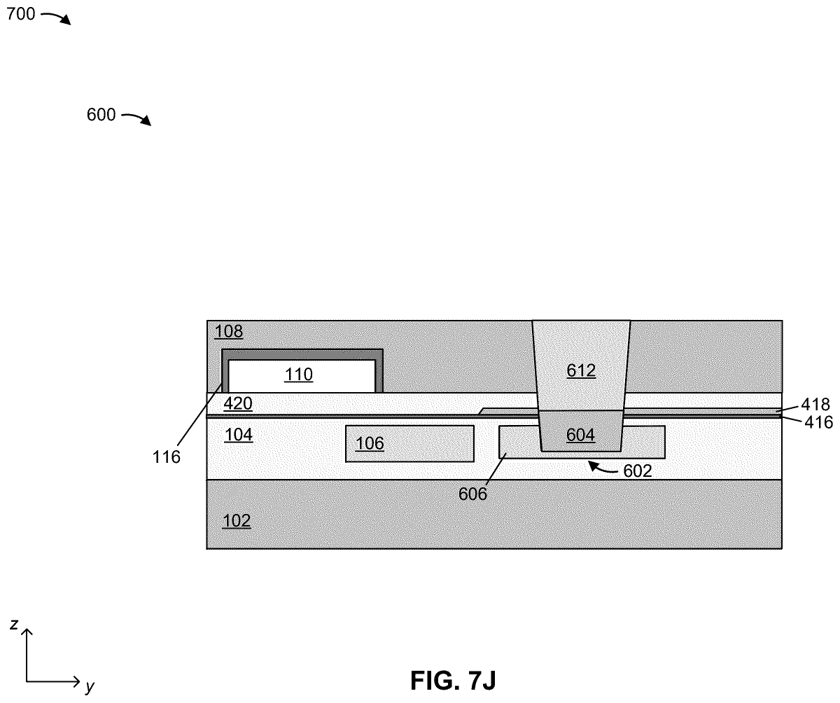

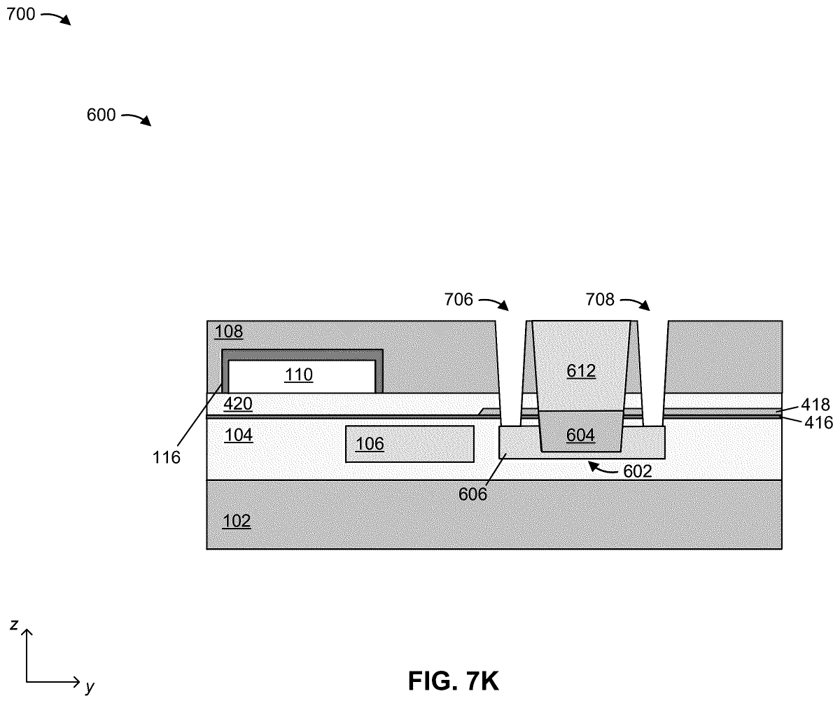

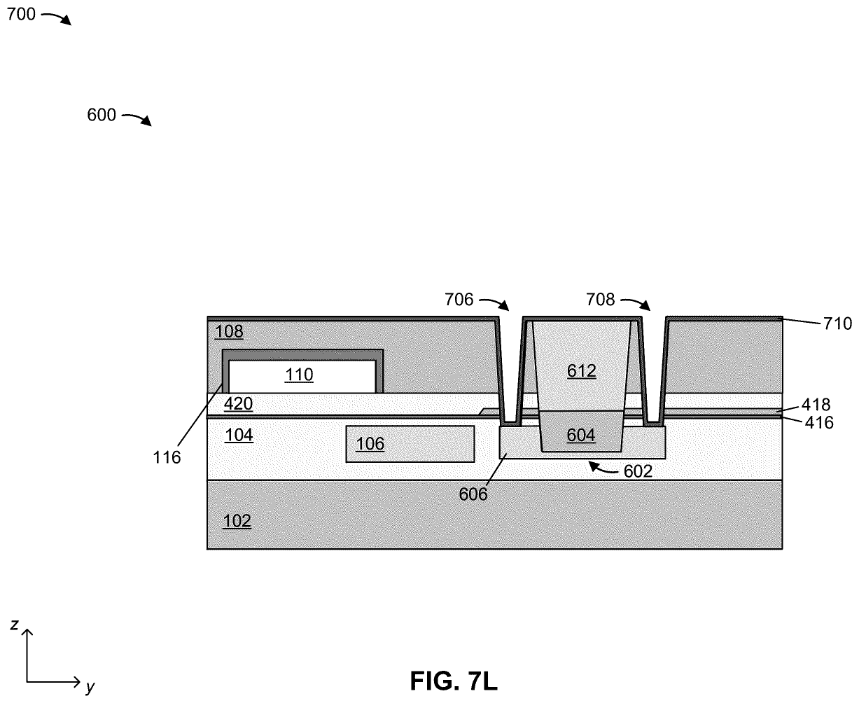

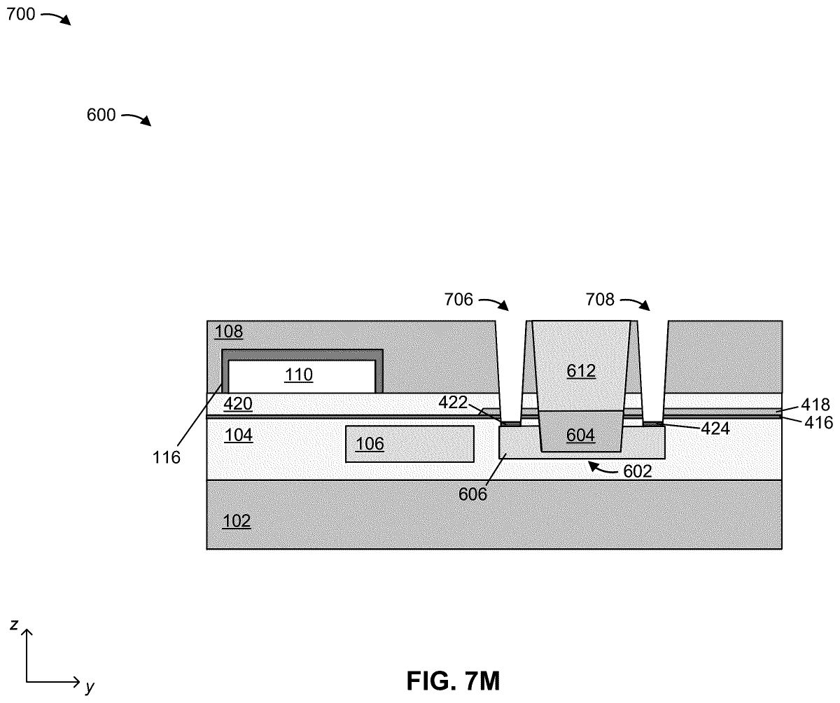

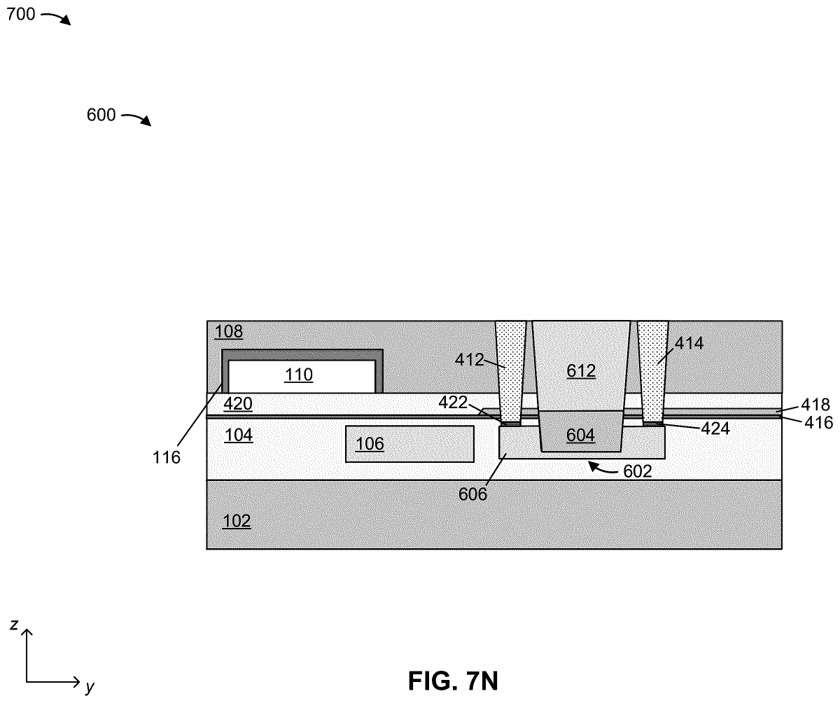

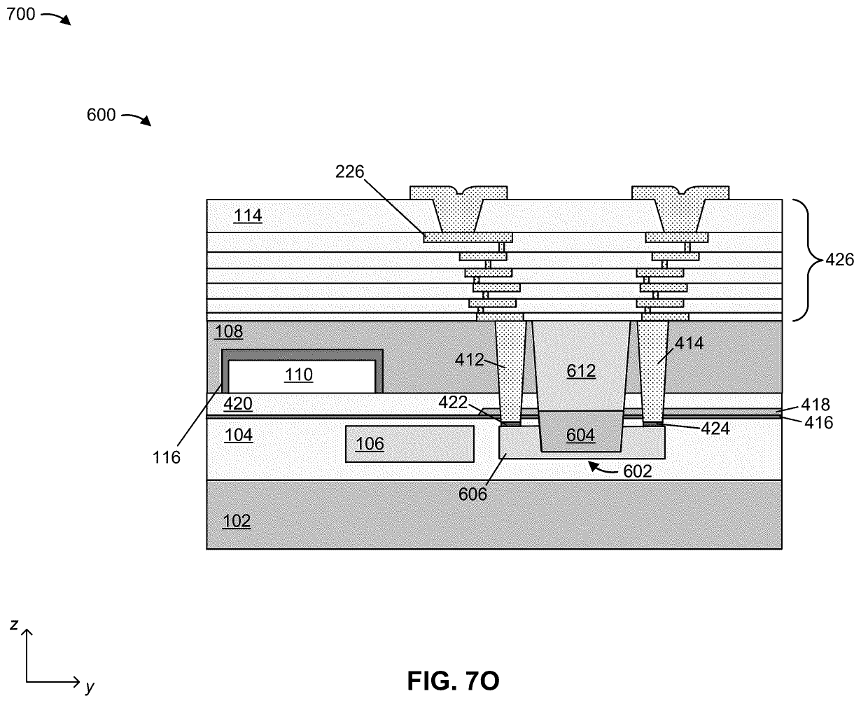

As described herein, such as in connection with FIGS. 7A-7O, the waveguide structure 110 may be formed and treated with high-temperature processes prior to formation of the absorption region 604. The semiconductor material (e.g., germanium (Ge)) of the absorption region 604 may be susceptible to increased dark current if subjected to the high-temperature processing of the waveguide structure 110. Thus, the formation and high-temperature treatment of the waveguide structure 110 prior to formation of the absorption region 604 may enable a low dark current to be achieved for the absorption region 604, which may enable a high optical sensitivity and/or increased low-light performance to be achieved for the photodetector structure 602.

The metal silicide layer 422 may be included between a terminal of the semiconductor base 606 of the photodetector structure 602 and the contact 412. The metal silicide layer 424 may be included between another terminal of the semiconductor base 606 of the photodetector structure 602 and the contact 414.

As further shown in FIG. 6, a region above the absorption region 604 may be filled with a dielectric plug 612. The dielectric plug 612 may be formed in the dielectric layer 108 to fill in a recess in the dielectric layer 108 in which the absorption region 604 was formed. The CESL 418 is not included over the absorption region 604 because the absorption region 604 may be formed after formation of the CESL 418, and the portion of the CESL 418 that was formed over the absorption region 604 was removed during formation of the recess and subsequently replaced with the dielectric plug 612. In some implementations, the top of the absorption region 604 may be below the CESL 418, may be located at an approximately same height as the CESL 418, or may be located above the CESL 418.

As indicated above, FIG. 6 is provided as an example. Other examples may differ from what is described with regard to FIG. 6.

FIGS. 7A-7O are diagrams of an example implementation 700 of forming the semiconductor photonics device 600 described herein. In particular, the example implementation 700 includes an example of bonding the waveguide structure 110 to the semiconductor photonics device 600 after the waveguide structure 110 and the photodetector structure 602 are formed. This limits the exposure of the semiconductor photonics components of the semiconductor photonics device 600 (and the associated metal silicide layers 418 and 420) to high temperatures that might otherwise damage and/or degrade the performance of the semiconductor photonics components. In some implementations, one or more of the operations described in connection with FIGS. 7A-7O may be performed using one or more semiconductor processing tools, such as a deposition tool, an exposure tool (e.g., a lithography tool), a developer tool, an etch tool, a planarization tool (e.g., a CMP tool, a wafer grinding tool), an ion implantation tool, an annealing tool, and/or a wafer/die transport tool, among other examples.

As shown in FIG. 7A, a substrate 702 of the semiconductor photonics device 600 may be provided. The substrate 702 may include an SOI substrate that includes the substrate layer 102 (e.g., a silicon (Si) substrate and/or another type of semiconductor substrate), a portion of the dielectric layer 104 (e.g., a BOX layer and/or another type of insulator layer) over and/or on the substrate layer 102, and the semiconductor layer 208 (e.g., a silicon (Si) layer and/or another type of semiconductor layer) over and/or on the portion of the dielectric layer 104.

As shown in FIG. 7B, the semiconductor waveguide structure 106 and the semiconductor base 606 of the photodetector structure 602 may be formed from the semiconductor layer 208 above the dielectric layer 104. In some implementations, one or more transistor structures 206 may be formed in and/or on the semiconductor layer 208.

In some implementations, a hard mask layer may be formed over and/or on the semiconductor layer 208, and a pattern in the hard mask layer may be used to etch the semiconductor layer 208 to form the semiconductor waveguide structure 106 and the semiconductor base 606 of the photodetector structure 602. Deposition tools may be used to deposit the hard mask layer on the semiconductor layer 208 (e.g., using a CVD technique, a PVD technique, and/or another type of deposition technique) and a photoresist layer on the hard mask layer (e.g., using a spin-coating technique and/or another type of deposition technique). The hard mask layer may include a silicon nitride (SiₓN_{y} such as Si₃N₄) material or another hard mask material. The photoresist layer may include a light-sensitive material that can be patterned using an exposure tool such as a DUV lithography tool and/or an EUV lithography tool, among other examples.

An exposure tool may be used to expose the photoresist layer to a radiation source to form a pattern in the photoresist layer. A developer tool may be used to develop and remove portions of the photoresist layer to expose the pattern. An etch tool may be used to etch the hard mask layer to transfer the pattern from the photoresist layer to the hard mask layer. An etch tool may then be used to etch the semiconductor layer 208 based on the pattern in the hard mask layer to remove material from the semiconductor layer 208 to form the semiconductor waveguide structure 106 and the semiconductor base 606 of the photodetector structure 602. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique).

As shown in FIG. 7C, additional material of the dielectric layer 104 may be deposited around and/or on the semiconductor waveguide structure 106 and the semiconductor base 606 of the photodetector structure 602 such that the semiconductor waveguide structure 106 and the semiconductor base 606 of the photodetector structure 602 are encapsulated in the dielectric layer 104. A deposition tool may be used to deposit the additional material of the dielectric layer 104 using a CVD technique, a PVD technique, an oxidation technique, and/or another type of deposition technique. In some implementations, a planarization tool is used to perform a planarization operation (e.g., a CMP operation) to planarize the dielectric layer 104 after the additional material of the dielectric layer 104 is deposited.

A shown in FIG. 7D, the RPO layer 416 may be formed on the dielectric layer 104, and the CESL 418 may be formed on the RPO layer 416. A deposition tool may be used to deposit the RPO layer 416 using a CVD technique, a PVD technique, an oxidation technique, and/or another type of deposition technique. In some implementations, a planarization tool is used to perform a planarization operation (e.g., a CMP operation) to planarize the RPO layer 416 after the additional material of the RPO layer 416 is deposited.

A deposition tool may be used to deposit the CESL 418 using a CVD technique, a PVD technique, an oxidation technique, and/or another type of deposition technique. In some implementations, a planarization tool is used to perform a planarization operation (e.g., a CMP operation) to planarize the CESL 418 after the additional material of the CESL 418 is deposited.

In some implementations, the CESL 418 is formed above the semiconductor waveguide structure 106 and above the semiconductor base 606 of the photodetector structure 602. In these implementations, the CESL 418 may be patterned and etched using etch tool to remove the portion of the CESL 418 above the semiconductor waveguide structure 106. In this way, the CESL 418 remains above the semiconductor base 606 of the photodetector structure 602 and is not included above the semiconductor waveguide structure 106.

A further shown in FIG. 7D, the interlayer oxide 420 may be formed on the RPO layer 416 and on the CESL 418. A deposition tool may be used to deposit the interlayer oxide 420 using a CVD technique, a PVD technique, an oxidation technique, and/or another type of deposition technique. In some implementations, a planarization tool is used to perform a planarization operation (e.g., a CMP operation) to planarize the interlayer oxide 420 after the additional material of the interlayer oxide 420 is deposited.

As shown in FIGS. 7E and 7F, the waveguide structure 110 may be formed on the interlayer oxide 420, and an annealing operation (e.g., a source/drain annealing operation) may be performed on the waveguide structure 110 in a similar manner as described in connection with FIGS. 3D and 3E. The annealing operation results in oxidation of the exposed surfaces of the waveguide structure 110, which causes the cladding layer 116 to be formed on the exposed surfaces of the waveguide structure 110. The annealing operation is performed prior to formation of the metal silicide layers 422 and 424 of the photodetector structure 602, and prior to formation of the absorption region 604 of the photodetector structure 602. This limits the exposure of the metal silicide layers 422 and 424 and the absorption region 604 to high temperatures, which enables a low contact resistance to be achieved for the photodetector structure 602 and enables a low dark current to be achieved for the photodetector structure 602.

As shown in FIG. 7G, the dielectric layer 108 may be formed on the interlayer oxide 420 and over the waveguide structure 110. A deposition tool may be used to deposit the dielectric layer 108 using a PVD technique, an ALD technique, a CVD technique, an oxidation technique, and/or another suitable deposition technique. The dielectric layer 108 may be deposited in one or more deposition operations. In some implementations, a planarization tool may be used to perform a planarization operation (e.g., a CMP operation) to planarize the dielectric layer 108 after the dielectric layer 108 is deposited.

As shown in FIG. 7H, a recess 704 may be formed above and into a portion of the semiconductor base 606 of the photodetector structure 602 such that a portion of the semiconductor base 606 of the photodetector structure 602 is exposed through the recess 704. The recess 704 may extend through the dielectric layer 108, through the interlayer oxide 420, through the CESL 418, through the RPO layer 416, and into a portion of the semiconductor base 606 of the photodetector structure 602.

In some implementations, a pattern in a photoresist layer is used to etch the dielectric layer 108, the interlayer oxide 420, the CESL 418, and/or the RPO layer 416 to form the recess 704. In these implementations, a deposition tool may be used to form the photoresist layer on the dielectric layer 108 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric layer 108, the interlayer oxide 420, the CESL 418, and/or the RPO layer 416 based on the pattern to form the recess 704. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recess 704 based on a pattern.

As shown in FIG. 7I, the absorption region 604 of the photodetector structure 602 may be formed in the recess 704 such that the absorption region 604 is recessed within the semiconductor base 606. Thus, the absorption region 604 is formed after the high-temperature processing is performed for the waveguide structure 110. The absorption region 604 may be formed by epitaxial growth, where layers of the absorption region 604 are deposited and annealed to form a particular crystalline structure for the absorption region 604.

As shown in FIG. 7J, the remaining area in the recess 704 above the absorption region 604 may be filled in with the dielectric plug 612. A deposition tool may be used to deposit the material of the dielectric plug 612 using a PVD technique, an ALD technique, a CVD technique, an oxidation technique, and/or another suitable deposition technique. The dielectric plug 612 may be deposited in one or more deposition operations. In some implementations, a planarization tool may be used to perform a planarization operation (e.g., a CMP operation) to planarize the dielectric plug 612 after the dielectric plug 612 is deposited.

As shown in FIG. 7K, recesses 706 and 708 may be formed over portions of the optical modulator structure 402 such that the portions of the photodetector structure 602 are exposed through the recesses 706 and 708. The recesses 706 and 708 may extend through the dielectric layer 108, through the interlayer oxide 420, through the CESL 418, and/or through the RPO layer 416 to the photodetector structure 602.

In some implementations, a pattern in a photoresist layer is used to etch the dielectric layer 108, the interlayer oxide 420, the CESL 418, and/or the RPO layer 416 to form the recesses 706 and 708. In these implementations, a deposition tool may be used to form the photoresist layer on the dielectric layer 108 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric layer 108, the interlayer oxide 420, the CESL 418, and/or the RPO layer 416 based on the pattern to form the recesses 706 and 708. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recesses 706 and 708 based on a pattern.

As shown in FIGS. 7L and 7M, the metal silicide layers 422 and 424 may be respectively formed in the recesses 706 and 708 prior to respectively forming the contacts 412 and 414 in the recesses 706 and 708. In other words, the metal silicide layers 422 and 424 of the photodetector structure 602 are formed after the annealing operation described above that was performed to achieve a low hydrogen concentration for the waveguide structure 110. As a result of the metal silicide layers 422 and 424 being formed in the recesses 706 and 708 (e.g., as opposed to the metal silicide layers 422 and 424 being formed prior to formation of the dielectric layer 108), the metal silicide layers 422 and 424 cover only the exposed portions of the top surfaces of the semiconductor base 606 of the photodetector structure 602 in the recesses 706 and 708.

In some implementations, the metal silicide layers 422 and 424 of the photodetector structure 602 are formed after formation of the absorption region 604 of the photodetector structure 602. In some implementations, the absorption region 604 of the photodetector structure 602 are formed after formation of the metal silicide layers 422 and 424 of the photodetector structure 602.

As shown in FIG. 7L, to form the metal silicide layers 422 and 424, a deposition tool may be used to form a metal layer 710 on the sidewalls and on the bottom surfaces of the recesses 706 and 708. The deposition tool or an annealing tool may be used to perform an annealing operation to achieve salicidation of the metal layer 710 and the semiconductor material of the semiconductor base 606 of the photodetector structure 602, resulting in formation of the metal silicide layers 422 and 424. As shown in FIG. 7M, unreacted material of the metal layer 710 on the sidewalls of the recesses 706 and 708, and on the top surface of the dielectric layer 108, may be subsequently removed.

As shown in FIG. 7N the contacts 412 and 414 may be respectively formed on the metal silicide layers 422 and 424 in the recesses 706 and 708. In some implementations, a deposition tool may be used to conformally deposit (e.g., using a CVD technique and/or an ALD technique) liners in the recesses 706 and 708, and a deposition tool may be used to deposit (e.g., using a PVD technique, a CVD technique, an ALD technique, an electroplating technique) the contacts 412 and 414 in the recesses 706 and 708.

As shown in FIG. 7O, the dielectric layers 114 and the interconnect structures 226 of the interconnect layer 426 may be formed above and/or on the dielectric layer 108 (e.g., after the contacts 412 and 414 are formed). A deposition tool may be used to deposit the dielectric layers 114 using a PVD technique, an ALD technique, a CVD technique, an oxidation technique, and/or another suitable deposition technique. A deposition tool may be used to deposit the interconnect structures 226 using a PVD technique, an ALD technique, a CVD technique, an electroplating technique, and/or another suitable deposition technique.

In some implementations, the dielectric layers 114 and the interconnect structures 226 of the interconnect layer 426 are formed sequentially. For example, a first dielectric layer 114 may be formed, recesses may be formed in the first dielectric layer 114, and a first layer of interconnect structures 226 may be formed in the recesses in the first dielectric layer 114. A second dielectric layer 114 may be formed on the first dielectric layer 114, recesses may be formed in the second dielectric layer 114, and a second layer of interconnect structures 226 may be formed in the recesses in the second dielectric layer 114. Additional dielectric layers 114 and interconnect structures 226 may be formed in a similar manner.

As indicated above, FIGS. 7A-7O are provided as an example. Other examples may differ from what is described with regard to FIGS. 7A-7O.

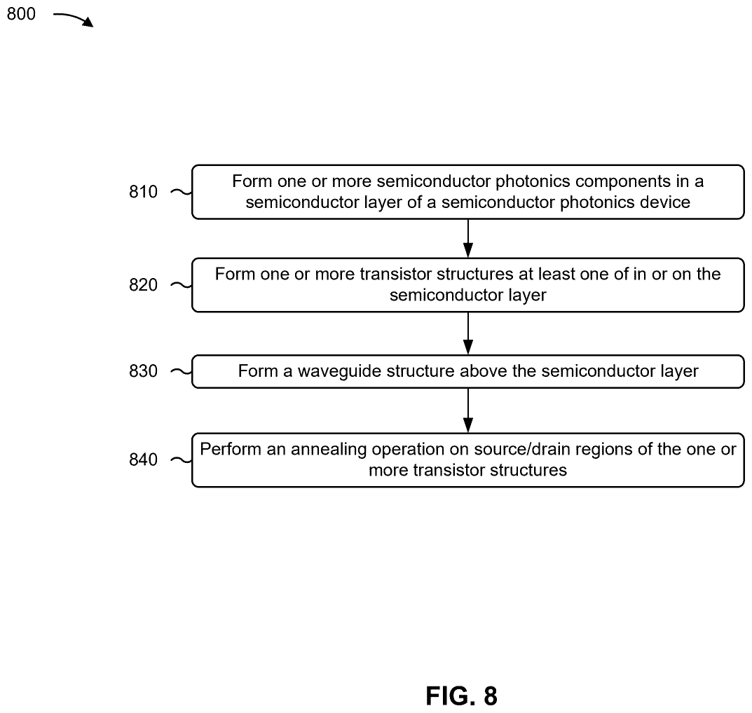

FIG. 8 is a flowchart of an example process 800 associated with forming a semiconductor photonics device described herein. In some implementations, one or more process blocks of FIG. 8 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 8, process 800 may include forming one or more semiconductor photonics components in a semiconductor layer of a semiconductor photonics device (block 810). For example, one or more semiconductor processing tools may be used to form one or more semiconductor photonics components (e.g., semiconductor waveguide structure 106, an optical modulator structure 402, a semiconductor base 606 of a photodetector structure 602) in a semiconductor layer (e.g., a semiconductor layer 208) of a semiconductor photonics device (e.g., a semiconductor photonics device 100, a semiconductor photonics device 400, a semiconductor photonics device 600), as described herein.

As further shown in FIG. 8, process 800 may include forming one or more transistor structures at least one of in or on the semiconductor layer (block 820). For example, one or more semiconductor processing tools may be used to form one or more transistor structures (e.g., one or more transistor structures 206) at least one of in or on the semiconductor layer, as described herein.

As further shown in FIG. 8, process 800 may include forming a waveguide structure above the semiconductor layer (block 830). For example, one or more semiconductor processing tools may be used to form a waveguide structure (e.g., a waveguide structure 110) above the semiconductor layer, as described herein.

As further shown in FIG. 8, process 800 may include performing an annealing operation on source/drain regions of the one or more transistor structures (block 840). For example, one or more semiconductor processing tools may be used to perform an annealing operation on source/drain regions (e.g., source/drain regions 210) of the one or more transistor structures, as described herein. In some implementations, the annealing operation results in formation of a cladding layer (e.g., a cladding layer 116) on the waveguide structure.

Process 800 may include additional implementations, such as any single implementation or any combination of implementations described below and/or in connection with one or more other processes described elsewhere herein.

In a first implementation, the cladding layer includes a silicon dioxide (SiO₂) cladding layer.

In a second implementation, alone or in combination with the first implementation, performing the annealing operation includes performing the annealing operation prior to forming metal silicide layers on the source/drain regions.

In a third implementation, alone or in combination with one or more of the first and second implementations, performing the annealing operation includes oxidizing exposed surfaces of the waveguide structure during the annealing operation.

In a fourth implementation, alone or in combination with one or more of the first through third implementations, oxidizing the exposed surfaces of the waveguide structure during the annealing operation includes oxidizing the exposed surfaces of the waveguide structure using an oxygen (O₂) gas and a hydrogen (H₂) gas.

In a fifth implementation, alone or in combination with one or more of the first through fourth implementations, oxidizing the exposed surfaces of the waveguide structure during the annealing operation includes exposing the exposed surfaces of the waveguide structure to the oxygen (O₂) gas and the hydrogen (H₂) gas at a temperature that is included in a range of approximately 900 degrees Celsius to approximately 1100 degrees Celsius.

In a sixth implementation, alone or in combination with one or more of the first through fifth implementations, a hydrogen concentration in the waveguide structure is lower after the annealing operation than prior to the annealing operation.

In a seventh implementation, alone or in combination with one or more of the first through sixth implementations, wherein forming the waveguide structure includes forming a metal waveguide structure, and performing the annealing operation includes oxidizing exposed surfaces of the metal waveguide structure during the annealing operation such that a metal-oxide layer is formed on the exposed surfaces of the metal waveguide structure.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

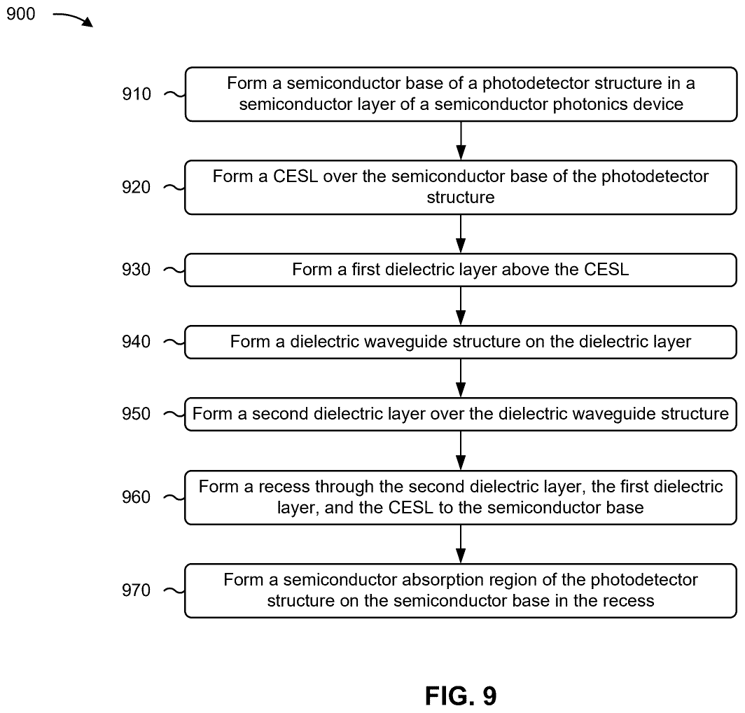

FIG. 9 is a flowchart of an example process 900 associated with forming a semiconductor photonics device described herein. In some implementations, one or more process blocks of FIG. 9 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 9, process 900 may include forming a semiconductor base of a photodetector structure in a semiconductor layer of a semiconductor photonics device (100) (block 910). For example, one or more semiconductor processing tools may be used to form a semiconductor base (e.g., a semiconductor base 606) of a photodetector structure (e.g., a photodetector structure 602) in a semiconductor layer (e.g., a semiconductor layer 208) of a semiconductor photonics device (e.g., a semiconductor photonics device 600), as described herein.

As further shown in FIG. 9, process 900 may include forming a CESL over the semiconductor base of the photodetector structure (block 920). For example, one or more semiconductor processing tools may be used to form a CESL (e.g., a CESL 418) over the semiconductor base of the photodetector structure, as described herein.

As further shown in FIG. 9, process 900 may include forming a first dielectric layer above the CESL (block 930). For example, one or more semiconductor processing tools may be used to form a first dielectric layer (e.g., an interlayer oxide 420) above the CESL, as described herein.

As further shown in FIG. 9, process 900 may include forming a dielectric waveguide structure on the dielectric layer (block 940). For example, one or more semiconductor processing tools may be used to form a dielectric waveguide structure (e.g., a waveguide structure 110) on the dielectric layer, as described herein.

As further shown in FIG. 9, process 900 may include forming a second dielectric layer over the dielectric waveguide structure (block 950). For example, one or more semiconductor processing tools may be used to form a second dielectric layer (e.g., a dielectric layer 108) over the dielectric waveguide structure, as described herein.

As further shown in FIG. 9, process 900 may include forming a recess through the second dielectric layer, the first dielectric layer, and the CESL to the semiconductor base (block 960). For example, one or more semiconductor processing tools may be used to form a recess (e.g., a recess 704) through the second dielectric layer, the first dielectric layer, and the CESL to the semiconductor base, as described herein.

As further shown in FIG. 9, process 900 may include forming a semiconductor absorption region of the photodetector structure on the semiconductor base in the recess (block 970). For example, one or more semiconductor processing tools may be used to form a semiconductor absorption region (e.g., an absorption region 604) of the photodetector structure on the semiconductor base in the recess, as described herein.

Process 900 may include additional implementations, such as any single implementation or any combination of implementations described below and/or in connection with one or more other processes described elsewhere herein.

In a first implementation, process 900 includes performing an annealing operation on the dielectric waveguide structure prior to forming the second dielectric layer and prior to forming the semiconductor absorption region.

In a second implementation, alone or in combination with the first implementation, the annealing operation results in formation of an oxide-containing dielectric cladding layer (e.g., a cladding layer 116) on the dielectric waveguide structure.

In a third implementation, alone or in combination with one or more of the first and second implementations, the annealing operation results in a reduction of hydrogen bonds in the dielectric waveguide structure.

In a fourth implementation, alone or in combination with one or more of the first through third implementations, process 900 includes forming another recess (e.g., a recess 706, a recess 708) through the second dielectric layer, the first dielectric layer, and the CESL to the semiconductor base, forming a metal layer (e.g., a metal layer 710) on sidewalls and on a bottom surface of the other recess, where the bottom surface of the other recess corresponds to a top surface of the semiconductor base, and performing an annealing operation on the metal layer to form a metal silicide layer (e.g., a metal silicide layer 422, a metal silicide layer 424) on the top surface of the semiconductor base in the other recess.

In a fifth implementation, alone or in combination with one or more of the first through fourth implementations, process 900 includes removing unreacted material of the metal layer from the sidewalls of the recess after the annealing operation.

In a sixth implementation, alone or in combination with one or more of the first through fifth implementations, process 900 includes performing another annealing operation on the metal silicide layer after removing the unreacted material.

In a seventh implementation, alone or in combination with one or more of the first through sixth implementations, process 900 includes filling a remaining area in the recess with a dielectric plug (e.g., a dielectric plug 612) above the semiconductor absorption region.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

In this way, a waveguide structure (e.g., a dielectric edge coupler waveguide, a metal edge coupler waveguide) of a semiconductor photonics device is formed and processed using high-temperature processing techniques to achieve a low hydrogen concentration for the waveguide structure prior to formation of semiconductor photonics components of the semiconductor photonics device that are susceptible to damage from high-temperature processing such as metal silicide layers and/or semiconductor-based photodetector absorption regions. The high-temperature processing of the waveguide structure may be performed as part of a high-temperature processing operation for other structures of the semiconductor photonics device, such as an annealing operation for source/drain regions of transistor structures of the semiconductor photonics device.

As described in greater detail above, some implementations described herein provide a method. The method includes forming one or more semiconductor photonics components in a semiconductor layer of a semiconductor photonics device. The method includes forming one or more transistor structures at least one of in or on the semiconductor layer. The method includes forming a waveguide structure above the semiconductor layer. The method includes performing an annealing operation on source/drain regions of the one or more transistor structures, where the annealing operation results in formation of a cladding layer on the waveguide structure.

As described in greater detail above, some implementations described herein provide a method. The method includes forming a semiconductor base of a photodetector structure in a semiconductor layer of a semiconductor photonics device. The method includes forming a CESL over the semiconductor base of the photodetector structure. The method includes forming a first dielectric layer above the CESL. The method includes forming a dielectric waveguide structure on the first dielectric layer. The method includes forming a second dielectric layer over the dielectric waveguide structure. The method includes forming a recess through the second dielectric layer, the first dielectric layer, and the CESL to the semiconductor base. The method includes forming a semiconductor absorption region of the photodetector structure on the semiconductor base in the recess.

As described in greater detail above, some implementations described herein provide a semiconductor photonics device. The semiconductor photonics device includes a first dielectric layer. The semiconductor photonics device includes an optical modulator structure in the first dielectric layer. The semiconductor photonics device includes a CESL over the optical modulator structure. The semiconductor photonics device includes a second dielectric layer above the CESL and above the first dielectric layer. The semiconductor photonics device includes a waveguide structure in the second dielectric layer. The semiconductor photonics device includes a conformal cladding layer between the waveguide structure and the second dielectric layer.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
forming one or more photonics components in a semiconductor layer of a semiconductor photonics device;
forming one or more transistor structures at least one of in or on the semiconductor layer;
forming a waveguide structure above the semiconductor layer; and
performing an annealing operation,
wherein the annealing operation results in formation of a cladding layer on the waveguide structure.

2. The method of claim 1, wherein the cladding layer comprises a silicon dioxide (SiO₂) cladding layer.

3. The method of claim 2, wherein performing the annealing operation comprises:
performing the annealing operation prior to forming metal silicide layers on source/drain regions of the one or more transistor structures.

4. The method of claim 1, wherein performing the annealing operation comprises:
oxidizing exposed surfaces of the waveguide structure during the annealing operation.

5. The method of claim 4, wherein oxidizing the exposed surfaces of the waveguide structure during the annealing operation comprises:
oxidizing the exposed surfaces of the waveguide structure using an oxygen (O₂) gas and a hydrogen (H₂) gas.

6. The method of claim 5, wherein oxidizing the exposed surfaces of the waveguide structure during the annealing operation comprises:
exposing the exposed surfaces of the waveguide structure to the oxygen (O₂) gas and the hydrogen (H₂) gas at a temperature that is included in a range of approximately 900 degrees Celsius to approximately 1100 degrees Celsius.

7. The method of claim 1, wherein forming the waveguide structure comprises:
forming a metal waveguide structure; and
wherein performing the annealing operation comprises:
oxidizing exposed surfaces of the metal waveguide structure during the annealing operation such that a metal-oxide layer is formed on the exposed surfaces of the metal waveguide structure.

8. A method, comprising:
forming a semiconductor base of a photodetector structure in a semiconductor layer of a semiconductor photonics device;
forming a contact etch stop layer (CESL) over the semiconductor base of the photodetector structure;
forming a first dielectric layer above the CESL;
forming a dielectric waveguide structure on the first dielectric layer;
forming a second dielectric layer over the dielectric waveguide structure;
forming a recess through the second dielectric layer, the first dielectric layer, and the CESL to the semiconductor base; and
forming a semiconductor absorption region of the photodetector structure on the semiconductor base in the recess.

9. The method of claim 8, further comprising:
performing an annealing operation on the dielectric waveguide structure prior to forming the second dielectric layer and prior to forming the semiconductor absorption region.

10. The method of claim 9, wherein the annealing operation results in formation of an oxide-containing dielectric cladding layer on the dielectric waveguide structure.

11. The method of claim 9, wherein the annealing operation results in a reduction of hydrogen bonds in the dielectric waveguide structure.

12. The method of claim 8, further comprising:
forming another recess through the second dielectric layer, the first dielectric layer, and the CESL to the semiconductor base;
forming a metal layer on sidewalls and on a bottom surface of the other recess,
wherein the bottom surface of the other recess corresponds to a top surface of the semiconductor base; and
performing an annealing operation on the metal layer to form a metal silicide layer on the top surface of the semiconductor base in the other recess.

13. The method of claim 12, further comprising:
removing material of the metal layer from the sidewalls of the other recess after the annealing operation.

14. The method of claim 13, further comprising:
performing another annealing operation on the metal silicide layer after removing the material of the metal layer.

15. The method of claim 13, further comprising:
filling a remaining area in the recess with a dielectric plug above the semiconductor absorption region.

16. A semiconductor photonics device, comprising:
a first dielectric layer;
an optical modulator structure in the first dielectric layer;
a contact etch stop layer (CESL) over the optical modulator structure;
a second dielectric layer above the CESL and above the first dielectric layer;
a waveguide structure in the second dielectric layer; and
a conformal cladding layer between the waveguide structure and the second dielectric layer.

17. The semiconductor photonics device of claim 16, wherein the CESL is substantially planar across the optical modulator structure.

18. The semiconductor photonics device of claim 16, wherein a thickness of the conformal cladding layer is included in a range of approximately 2 nanometers to approximately 5 nanometers.

19. The semiconductor photonics device of claim 16, wherein the waveguide structure comprises a silicon nitride (SiₓN_{y}) waveguide structure; and
wherein the conformal cladding layer comprises a conformal silicon oxide (SiOₓ) layer.

20. The semiconductor photonics device of claim 16, further comprising:
a metal silicide layer on a terminal of the optical modulator structure,
wherein the metal silicide layer is spaced apart from the CESL.
